(19) United States
(12) Patent Application Publication
(10) Pub. No.: US 2022/0212083 A1
(43) Pub. Date: Jul. 7, 2022

(54) GOLF COURSE AND METHOD OF PLAYING GOLF GAME

(71) Applicant: John Levack, Toronto (CA)

(72) Inventor: John Levack, Toronto (CA)

(21) Appl. No.: 16/974,327

(22) Filed: Jan. 4, 2021

(51) Int. Cl. A63B 69/36; A63B 71/06

(52) U.S. Cl. CPC A63B 69/3691; A63B 71/0622; A63B 71/0669; A63B 2071/0691; A63B 2071/0694

(57) ABSTRACT

A method is described for playing a golf game, on a working surface of a golf course. The method includes providing (using) a predetermined set of rules. The predetermined set of rules are configured to identify a range of golf clubs, of a set of golf clubs, to be utilized in such a way that the predetermined set of rules, in use, promotes, at least in part, a prolonged life span of at least some of the golf clubs.

### TECHNICAL FIELD

This document relates to the technical field of (and is not limited to): (A) a method of playing a golf game, on a working surface of a golf course, in accordance with a predetermined set of rules; and (B) a golf course having a working surface to be used with a method of playing a golf game in accordance with a predetermined set of rules; and (C) a working surface of a golf course to be used with a method of playing a golf game in accordance with a predetermined set of rules; and (D) a method of playing a golf game to be displayed on a display device of an electronic device that displays a working surface of a golf course, in which the method is played in accordance with a predetermined set of rules (golf rules).

### BACKGROUND

Golf players use golf clubs to hit golf balls into a series of holes located along a known golf course, preferably, in as few strokes as possible. The golf player with the lowest score (such as club strokes) may be declared the winner (for a given golf game). The known golf course may have an arranged progression of 18 holes.

### SUMMARY

It will be appreciated that there exists a need to mitigate (at least in part) at least one problem associated with existing (known) golf courses (also called the existing technology). After much study of, and experimentation with, the existing (known) golf courses, an understanding (at least in part) of the problems and potential solutions have been identified and are articulated as follows:

The known golf course may provide a different set of challenges depending on the design and layout. The known golf course may utilize a standardized playing area having 18 holes or courses, etc. The golf player is challenged with coping with the varied terrains encountered on the different courses, and this is a part of the known method of playing golf (a golf game). There are many forms of terrain positioned between the teeing green and the putting green (the target). Each hole may be, preferably, unique in its specific layout and arrangement. The game of golf may be played for (a) the lowest number of strokes by an individual (known as stroke play), or (b) the lowest score on the most individual holes in a complete round by an individual (or team) known as match play, etc. Stroke play is a game format for all skill levels, but more especially at the elite level.

The known golf course may include a tee (also called a tee box) where each hole (also called a course) begins. The tee has a close-cut area of grass. There may be several tees for golf players to choose from, depending on the skill level of the golf player. The forward tee, located closer to the fairway, may be reserved for golf players having fewer skills, with more skilled golf players likely choosing to hit from the rearward tee (that is, the tee furthest away from the green). The known golf course may include a fairway that has an area of short grass between the tee and the putting green. Hitting an approach shot out of the fairway allows the golf player to spin the golf ball more than they might by hitting from the rough. The way the golf player chooses to hit a shot (that is swing the golf club for striking the golf ball) from the fairway may change depending on the kind of grass on the fairway. A fairway having bent grass may tend to make larger divots, while other types of grass may make it more difficult to get the golf ball in the air. The known golf course may include a rough that has a longer-cut area of grass surrounding the fairway and the putting green. To be successful, the golf player may avoid the rough, which is normally allowed to grow longer the farther the rough is located from the putting green and fairway. Hitting from the rough means the golf player may use more club (that is, more strength to swing the golf club) than they normally would to reach the putting green. The known golf course may include a putting green that has the most closely mowed areas of grass. The putting green is where a cup is positioned or located. The golf ball is putted, by the golf player, into the cup. The known golf course may include a hazard. The hazard may be marked with red or yellow stakes, and may include features such as lakes, ponds, creeks, sand traps, etc.

The known method for play golf may be reconsidered (adapted) to provide at least one technical solution (such as, a method for playing a golf game, etc.) that may mitigate, at least in part, at least one technical problem (such as, premature wear and/or inadvertent damage, etc.) associated with at least one known golf implement (such as the golf clubs, etc.).

A first technical problem pertains to the golf clubs, such as the cost of the golf clubs, and more specifically to the premature wear of golf clubs leading to increased costs for the golf player. Known golf clubs are costly to own, maintain, replace, etc. Known golf clubs wear out with prolonged usage, leading to repairs, partial replacement of some golf clubs, replacement of the entire set of golf clubs, etc. For instance, a limited number of known golf clubs (of the set of golf clubs) may prematurely wear out in response to prolonged usage of the limited number of clubs, when, for instance, the golf player plays many golf games on the known 18-hole golf course (according to the known golf rules). For instance, a golf player (having a lower skill set, an average skill set, etc.) may, based on their limited skill set (or other reason(s), etc.), utilize (rely on) a very limited range of golf clubs from a set of available golf clubs. For instance, the golf player may tend to rely on the continued or prolonged usage of three types of golf clubs (such as, the number 1 (one) driver, the number 8 wedge club, and the putter) for all of the holes to be played during the known golf game. In this manner, the golf player may simply (conveniently) avoid using the remaining golf clubs; however, the golf player might not further develop their skills for using the remaining clubs. As a result of this case, reliance on a limited range of golf clubs may lead to premature weal of a limited number of known golf clubs in response to prolonged and over-focused usage of the limited number of golf clubs, which may also lead to a worsening play of the golf game while the remaining unused golf clubs remain unused for the most part.

To resolve, at least in part, the first technical problem, what may be desired is to have a method of playing a golf game that may, when used, prolong (at least in part) the life span of at least one golf implement (such as a golf club or the set of golf clubs, etc.). To resolve, at least in part, the first technical problem, what may be desired is to have a method of playing a golf game that may help the golf player maintain and/or improve their club-handling skills associated with usage of the golf clubs (preferably with most types of the golf clubs, all of the golf clubs of the set of golf clubs, etc.). What may be desired is to provide an adapted method of playing a golf game according to a predetermined set of rules (predetermined rules). The adapted method of playing the golf game may identify a wider variety of golf clubs to be selected from a set of golf clubs (preferably, all of the golf clubs) to be used during the golf game. In this arrangement, reduced wear may be imposed on a limited subset of golf clubs. As a result, the useful life of at least some of the golf clubs may be prolonged. As a result, the golf player may maintain and/or improve their skills associated with usage of a wider range (type) of golf clubs (preferably, with most or all of the golf clubs), thereby further reducing expenses for the golf player.

A second technical problem pertains to the golf balls, such as the cost of golf balls, and more specifically to the premature wearing (degradation) of the golf balls, and the premature damaging of a golf ball (etc.) leading to increased costs for the golf player. The management of the maintenance of the working surfaces of the known golf course may also have an impact on the degradation imparted to a golf ball. The working surface (also called the ground, playing surface, etc.) is a surface from which golf balls may be shot (by the golf player) toward a target (such as a cup). The working surface is, preferably, maintained in a good working condition so the golf player may properly hit the golf ball with a golf club (preferably, more accurately) towards the target (preferably, without negative interference from a badly-maintained working surface). When the working surface is not properly maintained, the golf player is prone to strike the golf ball in an improper way and, as a result, the golf ball may become inadvertently damaged (such as, when the ball becomes sliced by the head of the golf club, etc.). To reduce the damage to golf balls, regular maintenance is performed on the working surface. However, maintenance of the working surface for the known golf course requires much effort, cost, etc.

To resolve, at least in part, the second technical problem, what may be desired is to reduce the damage to golf balls while performing less maintenance on the working surface. To resolve, at least in part, the second technical problem, what may be desired is to have an adapted method of playing a game of golf that helps avoid or reduce maintenance of the working surface while allowing the golf player to reduce (avoid) the possibility of inflicting unwanted damage to the golf ball during the golf game. By using the golf game with a predetermined set of rules (golf rules), less maintenance of the golf course may be achieved on the basis that the golf rules may require fewer shots (club strokes) during the golf game (in comparison to the known golf game played on the known golf course). A lower requirement for performing maintenance of the golf course may lead to reduced incidents of unwanted damage to the golf ball thereby further reducing expenses for the golf player.

A third technical problem pertains to the golf glove, such as the cost of the golf glove, and, more specifically, the premature wearing (degradation) of a golf glove leading to increased costs for the golf player. The golf glove may help the golf player get a better grip of the golf club. However, the golf glove may be expensive. The golf player may use the golf glove for most golf shots (club swings). Frequent use of the golf glove may lead to increased wear and tear of the golf glove, leading to the premature replacement of the golf glove (thereby increasing costs and inconvenience), etc.

To resolve, at least in part, the third technical problem, what may be desired is to use a game of golf that may require fewer shots (club strokes) in comparison to the club strokes required to complete the known golf game. Consequently, the golf glove may last longer as a result of the golf player using the golf rules of the golf game, the golf course, etc., thereby further reducing expenses for the golf player.

A fourth technical problem pertains to the golf shoes, such as the cost of golf shoes, and, more specifically, to premature wearing (degradation) of golf shoes leading to increased costs for the golf player. Golf shoes may be expensive. Golf players may use a pair of golf shoes to improve their foot grip of the working surface (the ground), such as when the golf player swings the golf club for the maximum-possible speed so that the golf club may strike the golf ball in order to achieve a shot with a longer distance (provided other ideal conditions are maintained). Golf shoes may eventually break down (as a result of extended usage), thereby potentially imparting discomfort to the feet of the golf player and/or negatively influencing the club swing of the golf player and lead to unwanted (unintended) ball shots, unwanted trajectories, higher scores, etc.

To resolve, at least in part, the fourth technical problem, what may be desired is to use an adapted method of playing a golf game in which the distances walked along the golf course may be less compared to the distances walked along the known golf course. As a result, the golf shoes may last longer. As a result, the golf shoes may give the golf player a better stance and an improved club swing for a longer period of time. Keeping the golf shoes in good shape may help to (a) reduce the costs associated with golf shoes, (b) maintain and/or improve the golf skills of the golf players, (c) keep the golf shoes in good shape thereby help keep the golf player motivated to continue playing (for the long term), etc.

A fifth technical problem pertains to the usage of golf clubs, such as selecting the incorrect golf club (for a given shot to be taken during a golf game), the potential damage resulting from selecting and using the incorrect golf club. A difficult technical aspect of the known golf game is determining and selecting an appropriate golf club to be used in connection with a particular shot (to be taken). If the wrong golf club is selected and used for a required shot to be take, the golf club might impart damage to the golf ball, cause the golf ball to travel further (or shorter) than intended toward the intended desired target, etc.

To resolve, at least in part, the fifth technical problem, what may be desired is to use an adapted method of playing a golf game with golf rules on a golf course, in which golf players may be directed to use specific (predetermined) golf clubs (during the game) for specific shots to be taken (in accordance with a specific sequence or order of shots to be taken according to the predetermined set of rules (predetermined golf rules). The predetermined golf rules may indicate, to a golf player, which specific golf club to use for a particular shot to be taken so that there may be (a) a lower possibility of unwanted damage to the golf clubs, (b) a lower possibility of unwanted damage to the golf balls, (c) a better possibility for improved shot accuracy with improvements to golf skills, etc. The possible cost associated with selecting the incorrect golf club may be reduced (preferably avoided, if possible).

What might be needed is a golf game that may, in addition to resolving at least one technical problem, appeal to (a) a club golfer, (b) a potentially new golfer, (c) casual users who may wish to casually participate on occasion that, preferably, might improve their enjoyment of the golf game so much that they may become motivated to play more regularly, etc.

What might be needed is a golf game that may, in addition to resolving at least one technical problem, placate the non-golfing community, such as by requiring a much smaller parcel of land to play the game.

What might be needed is a golf game that may, in addition to resolving at least one technical problem, be formatted to enable, preferably, many (preferably, all) types of golf players so that they might address various skills required to play the known golf course in accordance with the known golf rules, preferably without taking up too much time, incurring too much expense, etc.

What might be needed is a golf game that may, in addition to resolving at least one technical problem, be appealing to an ardent golfer, a brand new participant, etc., while, preferably, permitting derivation of pleasure for satisfied game play.

What might be needed is a golf game that may, in addition to resolving at least one technical problem, provide a format broad enough to be played competitively and/or recreationally, preferably by any reasonable age, gender, skill level, etc.

To mitigate, at least in part, at least one problem associated with the existing technology, there is provided (in accordance with a major aspect) a method. The method is for playing a golf game on a working surface of a golf course. The method includes (comprises) providing (using) a predetermined set of rules configured to identify, to a golf player, a range of golf clubs (of a set of golf clubs) to be utilized. This is done, preferably, in such a way that the predetermined set of rules, in use, promotes, at least in part, a prolonged life span of at least some of the golf clubs.

To mitigate, at least in part, at least one problem associated with the existing technology, there is provided (in accordance with a major aspect) a golf course. The golf course has a working surface for use with a method of playing a golf game, in which the method includes using (providing) a predetermined set of rules configured to identify, to a golf player, a range of golf clubs (of a set of golf clubs) to be utilized in such a way that the predetermined set of rules promotes, at least in part, a prolonged life span of at least some of the golf clubs.

To mitigate, at least in part, at least one problem associated with the existing technology, there is provided (in accordance with a major aspect) a working surface of a golf course for use with a method of playing a golf game in accordance with a predetermined set of rules, in which the method includes using (providing) the predetermined set of rules configured to identify, to a golf player, a range of golf clubs, of a set of golf clubs, to be utilized in such a way that the predetermined set of rules promotes, at least in part, a prolonged life span of at least some of the golf clubs.

To mitigate, at least in part, at least one problem associated with the existing technology, there is provided (in accordance with a major aspect) an electronic device configured to display, on a display device, an image of a working surface of a golf course, the electronic device also configured to display and animate an electronically-simulated golf game in accordance with a method, the method includes using (providing) a predetermined set of rules configured to identify, to a golf player, a range of golf clubs (of a set of golf clubs) to be utilized in such a way that the predetermined set of rules promotes, at least in part, a prolonged life span of at least some of the golf clubs.

To mitigate, at least in part, at least one problem associated with the existing technology, there is provided (in accordance with a major aspect) a method of playing a golf game, on a working surface of a golf course, the method comprising providing a predetermined set of rules being configured to identify, to a golf player, a range of golf clubs of a set of golf clubs to be utilized in such a way that the predetermined set of rules, in use, promotes, at least in part, a prolonged life span of at least one golf club of the set of golf clubs.

To mitigate, at least in part, at least one problem associated with the existing technology, there is provided (in accordance with a major aspect) a method of playing a golf game, on a working surface of a golf course, the method comprising: (a) using a predetermined set of rules being configured to identify, to a golf player, a range of golf clubs of a set of golf clubs to be utilized; and (b) the predetermined set of rules includes predetermined shot numbers for indicating a number of club strokes to be taken by the golf player; and (c) the predetermined set of rules also includes a predetermined shot instruction: (i) being associated with a respective predetermined shot number; and (ii) being configured to instruct the golf player to stand at a predetermined location, on the working surface, from where the golf player is to take a shot toward a shot target for each predetermined shot number; and (d) the predetermined set of rules also includes a predetermined club-type identification: (i) being associated with a unique predetermined shot instruction; and (ii) being configured to identify a predetermined golf club to be used by the golf player.

To mitigate, at least in part, at least one problem associated with the existing technology, there is provided (in accordance with a major aspect) a method of playing a golf game, on a working surface of a golf course, the method comprising: (a) using a predetermined set of rules being configured to identify, to a golf player, a range of golf clubs of a set of golf clubs to be utilized in such a way that the predetermined set of rules, in use, promotes, at least in part, a prolonged life span of at least one golf club of the set of golf clubs; and (b) taking a set of predetermined shot numbers indicating a number of club strokes to be taken by the golf player as set out in the predetermined set of rules; and (c) executing at least one club stroke in accordance with a predetermined shot instruction: (i) being associated with each predetermined shot number as set out in the predetermined set of rules; and (ii) being configured to instruct the golf player to stand at a predetermined location, on the working surface, from where the golf player is to take a shot toward a shot target for each predetermined shot number as set out in the predetermined set of rules; and (d) executing said at least one club stroke with a predetermined club-type identification: (i) being associated with a unique predetermined shot instruction; and (ii) being configured to identify a predetermined golf club to be used by the golf player as set out in the predetermined set of rules.

To mitigate, at least in part, at least one problem associated with the existing technology, there is provided (in accordance with a major aspect) a golf course having a working surface for use with a method of playing a golf game.

To mitigate, at least in part, at least one problem associated with the existing technology, there is provided (in accordance with a major aspect) a working surface of a golf course for use with a method of playing a golf game in accordance with a predetermined set of rules.

To mitigate, at least in part, at least one problem associated with the existing technology, there is provided (in accordance with a major aspect) an electronic device configured to display, on a display device, an image of a working surface of a golf course, the electronic device also configured to display and animate an electronically-simulated golf game in accordance with a method.

To mitigate, at least in part, at least one problem associated with the existing technology, there is provided (in accordance with a major aspect) an apparatus, comprising: a golf course having a working surface. In accordance with an option, the apparatus may be adapted such that the golf course further comprises a power zone, including: (a) spaced-apart elongated power-zone golf-ball deflector assemblies positioned on opposite lateral sides of the power zone, and the spaced-apart elongated power-zone golf-ball deflector assemblies being configured to deflect, in use, at least one golf ball back to the power zone; and (b) a first power end section positioned between the spaced-apart elongated power-zone golf-ball deflector assemblies; and (c) a second power end section positioned between the spaced-apart elongated power-zone golf-ball deflector assemblies, and the second power end section spaced apart from the first power end section; and (d) a power tee positioned at the first power end section, and the power tee configured to provide an area for a golf player to strike a golf ball from the first power end section toward the second power end section and between the spaced-apart elongated power-zone golf-ball deflector assemblies; and (e) spaced-apart distance markers configured to: extend between the spaced-apart elongated power-zone golf-ball deflector assemblies; and be positioned from the first power end section to the second power end section; and provide visual feedback as to a distance travelled by the golf ball along the power zone; and (f) a target zone configured to: be positioned between the spaced-apart elongated power-zone golf-ball deflector assemblies; and be positioned proximate to the second power end section; and provide visual target for hitting the golf ball from the first power end section.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 and FIG. 2 depict top views of a first embodiment (implementation) of a golf course; and

FIG. 3 depicts a front view schematic of a predetermined set of golf rules applicable to men that use the embodiment (implementation) of the golf course of FIG. 1 and FIG. 2; and

FIG. 4 depicts a front view schematic of a predetermined set of golf rules applicable to women that use the embodiment (implementation) of the golf course of FIG. 1 and FIG. 2; and

FIG. 5 and FIG. 6 depict top views of a second embodiment (implementation) of a golf course; and

FIG. 7 depicts a front view schematic of a predetermined set of golf rules applicable to men that use the embodiment (implementation) of the golf course of FIG. 5 and FIG. 6; and

FIG. 8 depicts a front view schematic of a predetermined set of golf rules applicable to women that use the embodiment (implementation) of the golf course of FIG. 5 and FIG. 6; and

FIG. 9 depicts a top view of an embodiment (implementation) of a third embodiment (implementation) of golf course; and

FIG. 10 depicts a front view schematic of a predetermined set of golf rules applicable to men that use the embodiment (implementation) of the golf course of FIG. 9; and

FIG. 11 depicts a front view schematic of a predetermined set of golf rules applicable to women that use the embodiment (implementation) of the golf course of FIG. 9; and

FIG. 12 and FIG. 13 depict top views of a fourth embodiment (implementation) of a golf course; and

FIG. 14 depicts a top view of a fifth embodiment (implementation) of a golf course, which is a synergistic combination of (a) the embodiment (implementation) of the golf course of FIG. 1 and FIG. 2, (b) the embodiment (implementation) of the golf course of FIG. 5 and FIG. 6, and (c) the embodiment (implementation) of the golf course of FIG. 9; and

FIG. 15 depicts a front view of a golf scorecard applicable to men that use (a) the embodiment (implementation) of the golf course of FIG. 1 and FIG. 2, (b) the embodiment (implementation) of the golf course of FIG. 5 and FIG. 6, and (c) the embodiment (implementation) of the golf course of FIG. 9; and

FIG. 16 depicts a front view of a golf scorecard applicable to women that use (a) the embodiment (implementation) of the golf course of FIG. 1 and FIG. 2, (b) the embodiment (implementation) of the golf course of FIG. 5 and FIG. 6, and (c) the embodiment (implementation) of the golf course of FIG. 9; and

FIG. 17 depicts a schematic view of an electronic device configured to display, on a display device, an image of a working surface of a golf course, and the electronic device is also configured to display and animate an electronically-simulated golf game in accordance with a method.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, and well-understood, elements that are useful in commercially feasible embodiments are often not depicted to provide a less obstructed view of the embodiments of the present disclosure.

### LISTING OF REFERENCE NUMERALS USED IN THE DRAWINGS

golf course 100
working surface 101
security net 102
first power tee 104
second power tee 106
distance markers 108
target zone 110
rough portion 112
rough portion 114
sand trap 116
accuracy-target area 118
cup 120
accuracy-zone tee 122
power zone 200
accuracy zone 300
reward zone 400
predetermined set of rules 500
predetermined set of first-round rules 501
predetermined set of second-round rules 502
predetermined set of first-round rules 511
predetermined set of second-round rules 512
predetermined set of first-round rules 601
predetermined set of second-round rules 602
predetermined set of first-round rules 611
predetermined set of second-round rules 612
predetermined set of first-round rules 701
predetermined set of second-round rules 702
predetermined set of first-round rules 711
predetermined set of second-round rules 712
method 800
electronic device 900
display 902

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the disclosure is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the disclosure is limited to the subject matter provided by the claims, and that the disclosure is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

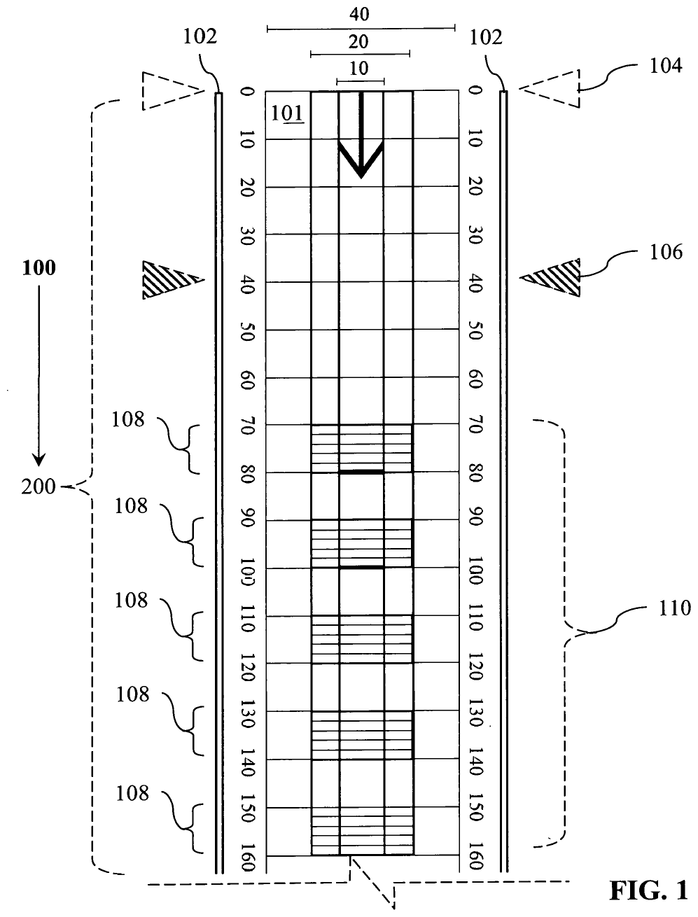

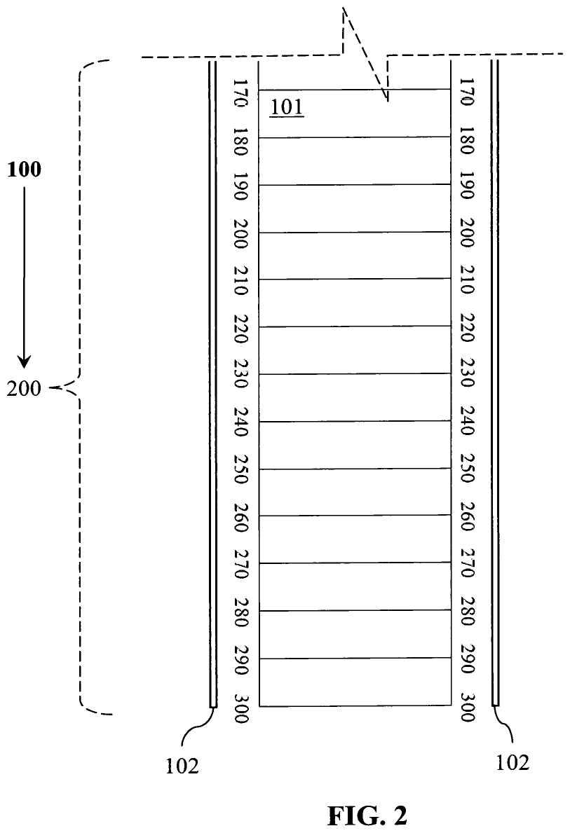

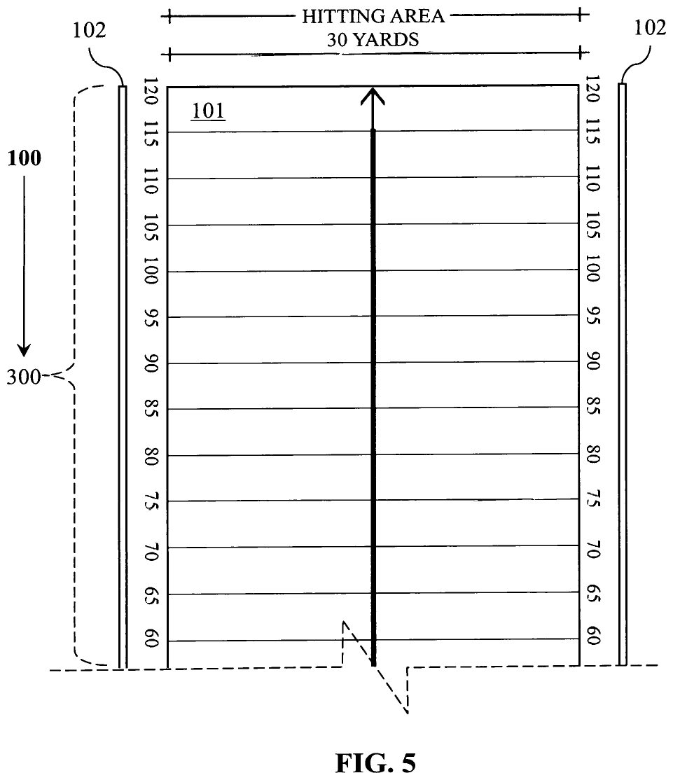

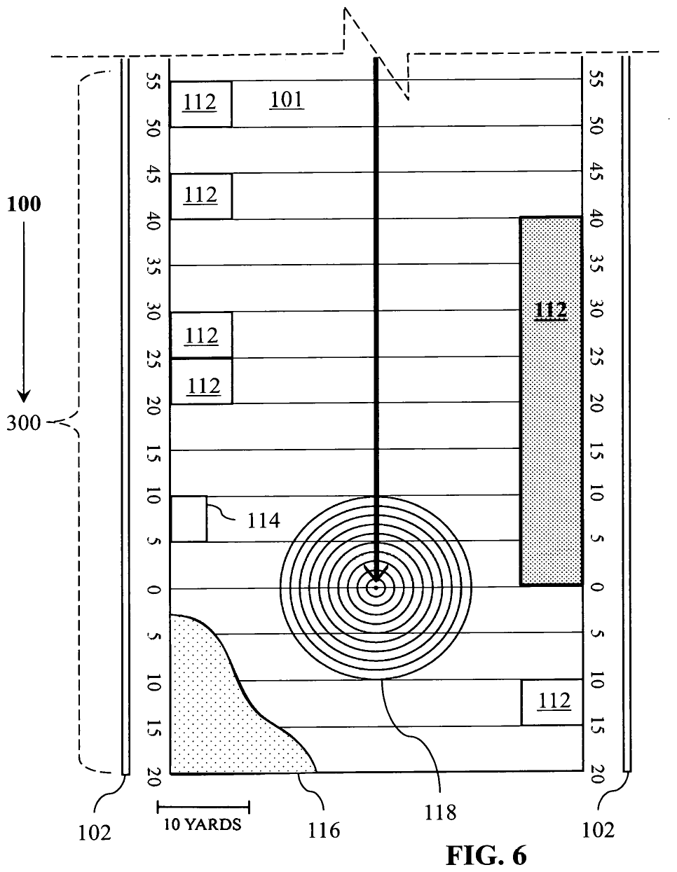

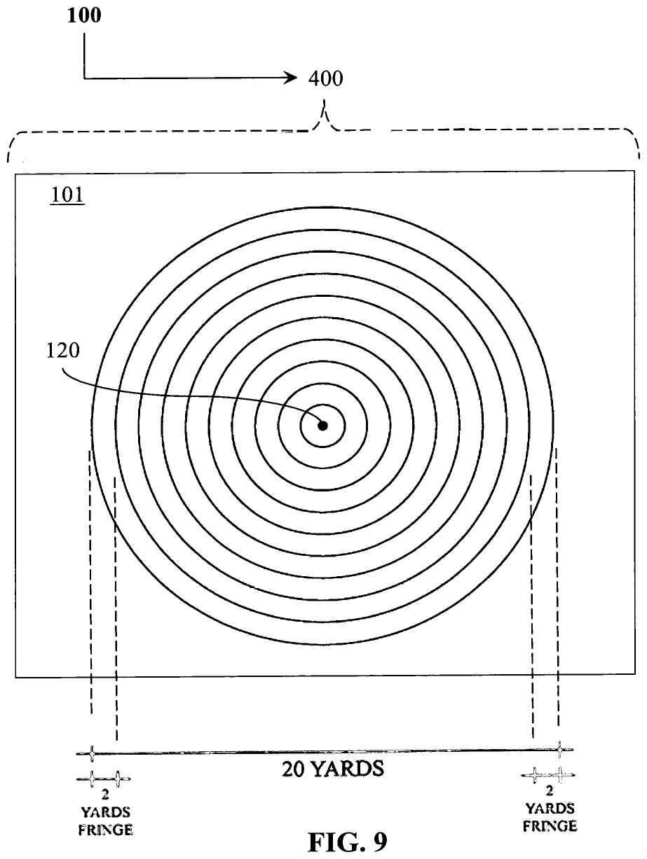

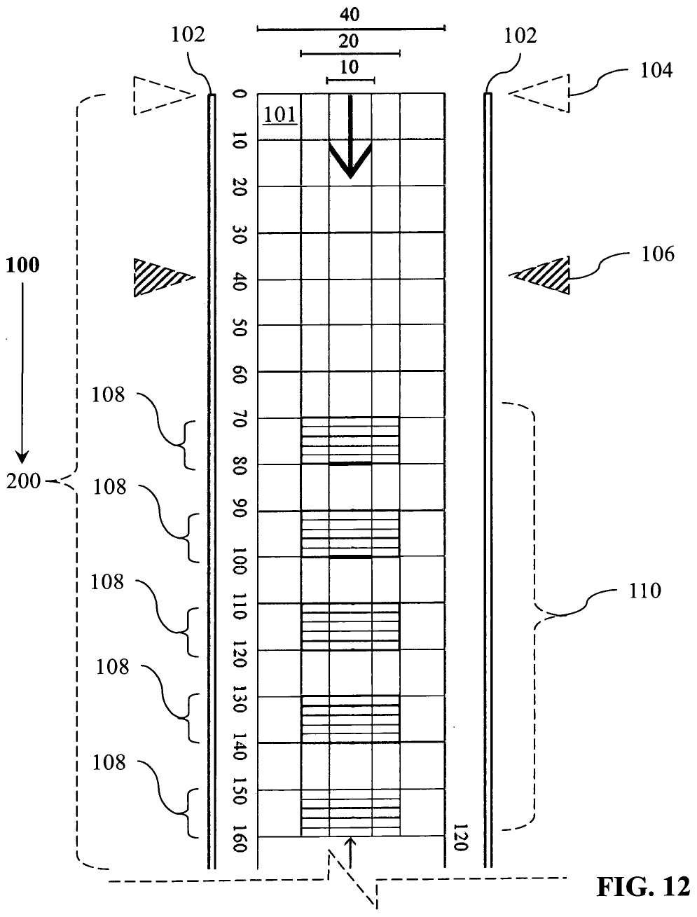

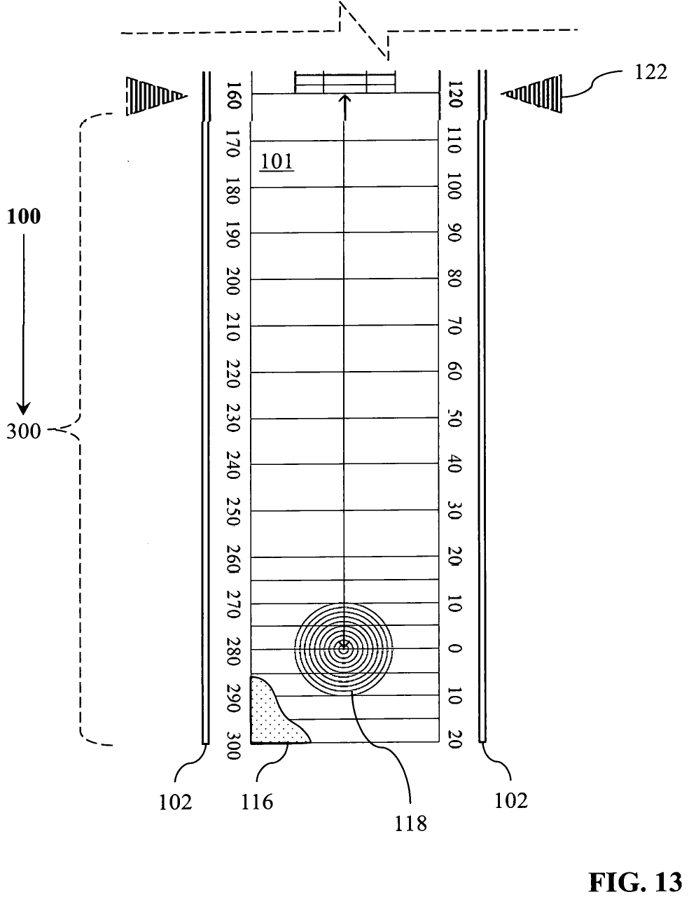

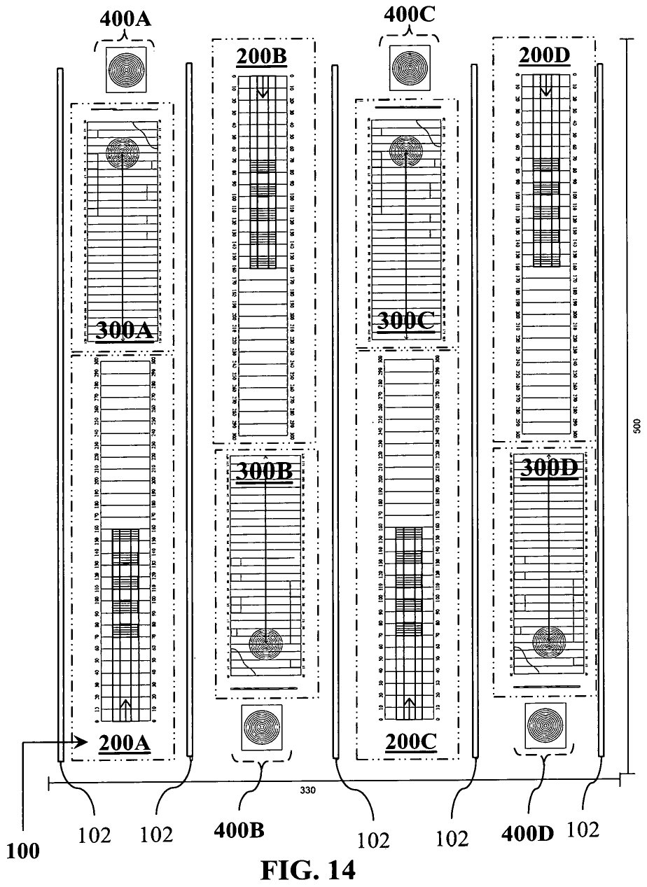

FIG. 1 and FIG. 2 depict top views of a first embodiment (implementation) of a golf course 100. FIG. 5 and FIG. 6 depict top views of a second embodiment (implementation) of a golf course 100. FIG. 9 depicts a top view of an embodiment (implementation) of a third embodiment (implementation) of golf course 100. FIG. 12 and FIG. 13 depict top views of a fourth embodiment (implementation) of a golf course 100. FIG. 14 depicts a top view of a fifth embodiment (implementation) of a golf course 100, which is a synergistic combination of (a) the embodiment (implementation) of the golf course 100 of FIG. 1 and FIG. 2, (b) the embodiment (implementation) of the golf course 100 of FIG. 5 and FIG. 6, and (c) the embodiment (implementation) of the golf course 100 of FIG. 9.

Referring to FIG. 1, FIG. 2, FIG. 5, FIG. 6 and FIG. 9, there is depicted a golf course 100 having a working surface 101. The golf course 100 further includes (preferably) a power zone 200 (as depicted in FIG. 1 and FIG. 2). The power zone 200 includes (preferably) spaced-apart elongated power-zone golf-ball deflector assemblies 102 positioned on opposite lateral sides of the power zone 200. The spaced-apart elongated power-zone golf-ball deflector assemblies 102 are configured to deflect, in use, at least one golf ball back to the power zone 200. The power zone 200 also includes (preferably) a first power end section (also called a first power-zone end section) positioned between the spaced-apart elongated power-zone golf-ball deflector assemblies 102. The power zone 200 also includes (preferably) a second power end section (also called a second power-zone end section) positioned between the spaced-apart elongated power-zone golf-ball deflector assemblies 102. The second power end section is (preferably) spaced apart from the first power end section. The power zone 200 also includes (preferably) a power tee positioned at the first power end section. The power tee is (preferably) configured to provide an area for a golf player to strike a golf ball (at least one golf ball) from the first power end section toward the second power end section and between the spaced-apart elongated power-zone golf-ball deflector assemblies 102. The power zone 200 also includes (preferably) spaced-apart distance markers 108 configured to: (a) extend between the spaced-apart elongated power-zone golf-ball deflector assemblies 102; and (b) be position from the first power end section to the second power end section; and (c) provide visual feedback as to a distance travelled by the golf ball along the power zone 200. The power zone 200 also includes (preferably) a target zone 110 configured to: (a) be positioned between the spaced-apart elongated power-zone golf-ball deflector assemblies 102; and (b) be positioned proximate to the second power end section; and (c) provide visual target for hitting the golf ball from the first power end section. The power zone 200 also includes (preferably) spaced-apart elongated lateral sides respectively extending along the spaced-apart elongated power-zone golf-ball deflector assemblies 102. The golf course 100 further includes (preferably) an accuracy zone 300 (as depicted in FIG. 5 and FIG. 6). The accuracy zone 300 includes (preferably) spaced-apart elongated golf-ball accuracy-zone deflector assemblies 102 positioned on opposite lateral sides of the accuracy zone 300. The spaced-apart elongated accuracy-zone golf-ball deflector assemblies 102 are (preferably) configured to deflect, in use, at least one golf ball back to the accuracy zone 300. The accuracy zone 300 includes (preferably) a first accuracy end section (also called a first accuracy-zone end section) positioned between the spaced-apart elongated accuracy-zone golf-ball deflector assemblies 102. The accuracy zone 300 includes (preferably) a second accuracy end section (also called a second accuracy-zone end section) positioned between the spaced-apart elongated accuracy-zone golf-ball deflector assemblies 102. The second accuracy end section is (preferably) spaced apart from the first accuracy end section. The first accuracy end section and the second accuracy end section spaced apart from each other. The first accuracy end section is configured (preferably) to provide an area for the golf player to strike the golf ball (a) from the first accuracy end section toward the second accuracy end section, and (b) between the spaced-apart elongated accuracy-zone golf-ball deflector assemblies 102. The accuracy zone 300 also includes (preferably) a rough portion 112 positioned between the spaced-apart elongated accuracy-zone golf-ball deflector assemblies 102. The rough portion 112 is (preferably) also positioned between the first accuracy end section and the second accuracy end section. The accuracy zone 300 also includes (preferably) a sand trap 116 positioned between the spaced-apart elongated accuracy-zone golf-ball deflector assemblies 102. The rough portion 112 is also (preferably) positioned between the first accuracy end section and the second accuracy end section. The accuracy zone 300 also includes (preferably) an accuracy-target area 118 configured to: (a) be positioned between the spaced-apart elongated accuracy-zone golf-ball deflector assemblies 102; and (b) be positioned proximate to the second accuracy end section; and (c) provide visual target for hitting the golf ball from the first accuracy end section. The accuracy zone 300 also includes (preferably) spaced-apart elongated lateral sides respectively extending along the spaced-apart elongated accuracy-zone golf-ball deflector assemblies 102. The golf course 100 further includes (preferably) a reward zone 400 (as depicted in FIG. 9). The reward zone 400 includes (preferably) a cup 120 configured to receive a rolling golf ball. The reward zone 400 also includes (preferably) a set of spaced-apart concentric visual rings of different diameters concentrically surrounding the cup 120. The set of spaced-apart concentric visual rings are (preferably) configured to respectively measure a remaining distance to the cup 120.

Referring to the embodiments (implementations) as depicted in FIG. 1, FIG. 2, FIG. 5, FIG. 6, FIG. 9, FIG. 12, FIG. 13 and FIG. 14, a golf course 100 includes at least one zone (type of zone, or more than one zone, in any quantity that may be desired).

Referring to the embodiments (implementations) as depicted in FIG. 1 and FIG. 2, the golf course 100 may include a power zone 200 (also called a power-discipline zone) in any desired quantity and/or shape thereof, etc. The power zone 200 defines an elongated working surface 101 having a predetermined elongated length (such as 300 yards) and a predetermined width (such as 40 yards).

Referring to the embodiments (implementations) as depicted in FIG. 1 and FIG. 2, the power zone 200 includes opposite elongated lateral sides. The power zone 200 includes end sections. The power zone 200 includes spaced-apart elongated golf-ball deflector assemblies 102 positioned and extending along the opposite elongated lateral sides (between the end sections). The spaced-apart elongated golf-ball deflector assemblies 102 may include, for instance, elongated nets, security nets, a containment device, etc., and any equivalent thereof. The spaced-apart elongated golf-ball deflector assemblies 102 are configured to deflect golf balls back to the working surface 101 of the power zone 200.

Referring to the embodiments (implementations) as depicted in FIG. 1, the power zone 200 may include a first power tee 104 positioned at an end section of the power zone 200. The first power tee 104 is configured to provide an area for a golf player (such as a golf player having a more powerful club-stroke capability) so that the golf player may strike a golf ball toward the opposite end of the power zone 200. The first power tee 104 may, for instance, be dedicated for use by a more experienced golf player (if desired). The first power tee 104 may be positioned at the zero yard marker.

Referring to the embodiments (implementations) as depicted in FIG. 1, the power zone 200 may include a second power tee 106 positioned at an end section of the power zone 200. The second power tee 106 is spaced apart from the first power tee 104. The second power tee 106 is configured to provide an area for a golf player (such as a golf player having a less powerful club-stroke capability) so that the golf player may strike a golf ball toward the opposite end of the power zone 200. The second power tee 106 may, for instance, be dedicated for use by a less-experienced golf player (if desired). The first power tee 104 may be positioned at the 40 yard marker.

Referring to the embodiments (implementations) as depicted in FIG. 1, the power zone 200 may include spaced-apart distance markers 108 spaced apart by two yards. The spaced-apart distance markers 108 are configured to provide visual feedback to the golf player as to the distance travelled by the golf ball along the power zone 200. The spaced-apart distance markers 108 extend between any one of: (a) the 70 yard marker to the 80 yard marker; and (b) the 90 yard marker to the 100 yard marker; and (c) the 110 yard marker to the 120 yard marker; and (d) the 130 yard marker to the 140 yard marker; and (e) the 150 yard marker to the 160 yard marker.

Referring to the embodiments (implementations) as depicted in FIG. 1, the power zone 200 may include a target zone 110 (also called an accuracy-hitting area). The target zone 110 has: (a) a predetermined elongated length (such as 90 yards extending from the 70 yard marker to the 160 yard marker), (b) a predetermined width (such as 20 yards extending from side to side and centred between the opposite elongated sides), etc. In addition, the target zone 110 may include an interior target zone having: (a) a predetermined elongated length (such as 90 yards extending from the 70 yard marker to the 160 yard marker); and (b) a predetermined width (such as 10 yards side to side extending from side to side and centred between the opposite elongated sides).

Referring to the embodiments (implementations) as depicted in FIG. 5 and FIG. 6, the golf course 100 may, as depicted in FIG. 5 and FIG. 6, include an accuracy zone 300 (also called an accuracy-discipline zone) in any desired quantity and/or shape thereof, etc. The accuracy zone 300 defines an elongated working surface 101 having a predetermined elongated length. The predetermined elongated length may extend, for instance, from the 120 yard marker (as depicted in FIG. 5) to a zero yard marker (as depicted in FIG. 6) and then extending toward the 20 yard marker (as depicted in FIG. 6). The accuracy zone 300 defines an elongated working surface 101 having a predetermined width (such as 30 yards).

Referring to the embodiments (implementations) as depicted in FIG. 5 and FIG. 6, the accuracy zone 300 includes opposite elongated lateral sides. The accuracy zone 300 includes end sections. The accuracy zone 300 includes spaced-apart elongated golf-ball deflector assemblies 102 positioned and extending along the opposite elongated lateral sides (between the end sections). The spaced-apart elongated golf-ball deflector assemblies 102 are configured to deflect golf balls back to the working surface 101 of the accuracy zone 300.

Referring to the embodiment (implementation) as depicted in FIG. 5, the accuracy zone 300 includes an area for a golf player to strike a golf ball from one end section toward the opposite end of the accuracy zone 300.

Referring to the embodiment (implementation) as depicted in FIG. 6, the accuracy zone 300 includes a rough portion 112 positioned on at least one lateral side of the accuracy zone 300. The rough portion 112 may be positioned on at least one lateral side of the accuracy zone 300. The rough portion 112 may be positioned on, and extend between, the 40 yard marker and the zero (0) yard marker. The rough portion 112 may be positioned on, and extend behind, the zero yard marker from between the ten (10) yard marker and the 20 yard marker. It will be appreciated that several instances of the rough portion 112 may be positioned in a spaced-apart relationship. The rough portions 112 may be positioned on opposite lateral sides of the accuracy zone 300. A rough portion 114 may be included and may be smaller than the rough portion 112.

Referring to the embodiment (implementation) as depicted in FIG. 6, the accuracy zone 300 includes a sand trap 116 positioned at one end section of the accuracy zone 300.

Referring to the embodiment (implementation) as depicted in FIG. 6, the accuracy zone 300 includes an accuracy-target area 118. The accuracy-target area 118 is configured to provide a target. The golf player may shoot their golf ball towards the accuracy-target area 118 (preferably, to the centre thereof). The accuracy-target area 118 includes, preferably, a set of concentric rings (of different diameters) positioned around a central spot, in which the rings may be utilized for measuring the distance to a central spot or zone.

Referring to the embodiment (implementation) as depicted in FIG. 9, the golf course 100 may include a reward zone 400 (also called a reward-discipline zone) in any desired quantity and/or shape thereof, etc. The reward zone 400 includes a cup 120 (a hole). The golf player may shoot their golf ball towards, and into, the cup 120. The cup 120 is surrounded by a set of concentric rings of different diameters, in which the rings may be utilized for measuring the remaining distance to the cup 120. The distance between the rings may be separated, for instance, by two yards.

The outer diameter of the set of concentric rings may be 20 yards.

Referring to the embodiments (implementations) as depicted in FIG. 12 and FIG. 13, the golf course 100 includes a synergistic combination of the power zone 200 (as depicted in FIG. 12) and the accuracy zone 300 (as depicted in FIG. 13), in any desired quantity and/or shape thereof, etc. The power zone 200 (as depicted in FIG. 12) may be similar, at least in part, to the layout of the power zone 200 as depicted in FIG. 1 and FIG. 2. The accuracy zone 300 (as depicted in FIG. 12) may be similar, at least in part, to the layout of the accuracy zone 300, as depicted in FIG. 5 and FIG. 6. The golf course 100 may include the combination of the power zone 200 (as depicted in FIG. 12) and the accuracy zone 300 (as depicted in FIG. 13) to accommodate a situation where there is a limit to the size of available land (for installing the golf course 100).

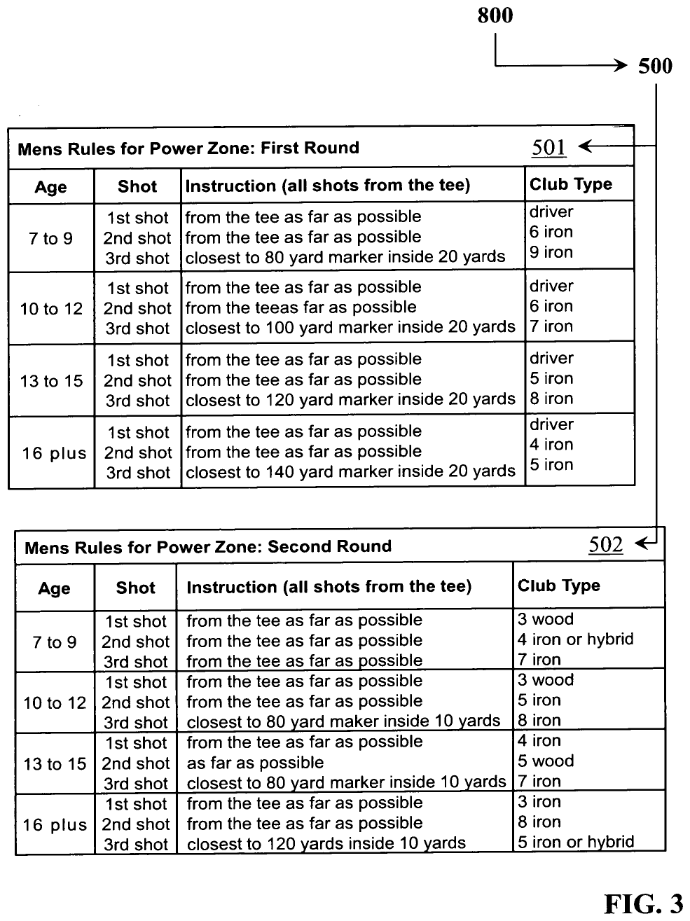

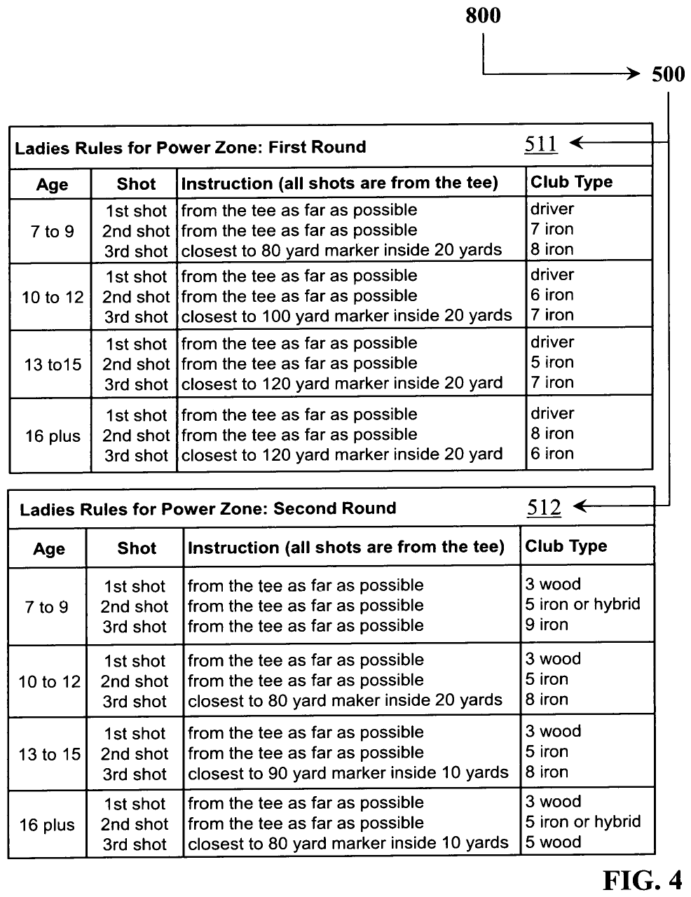

Referring to the embodiments (implementations) as depicted in FIG. 12 and FIG. 13, a first set of spaced-apart yardage markers may extend along one side (as indicated on the left side) of the combination of the power zone 200 (as depicted in FIG. 12) and the accuracy zone 300 (as depicted in FIG. 13). The first set of spaced-apart yardage markers may extend, for instance, from the zero yard marker (as depicted in FIG. 12) to the 300 yard marker (as depicted in FIG. 13). The first set of spaced-apart yardage markers may be utilized for indicating yardage for the case where the combination (of the power zone 200 and the accuracy zone 300) is utilized with the predetermined set of rules 500, as depicted in FIG. 3 and/or FIG. 4.

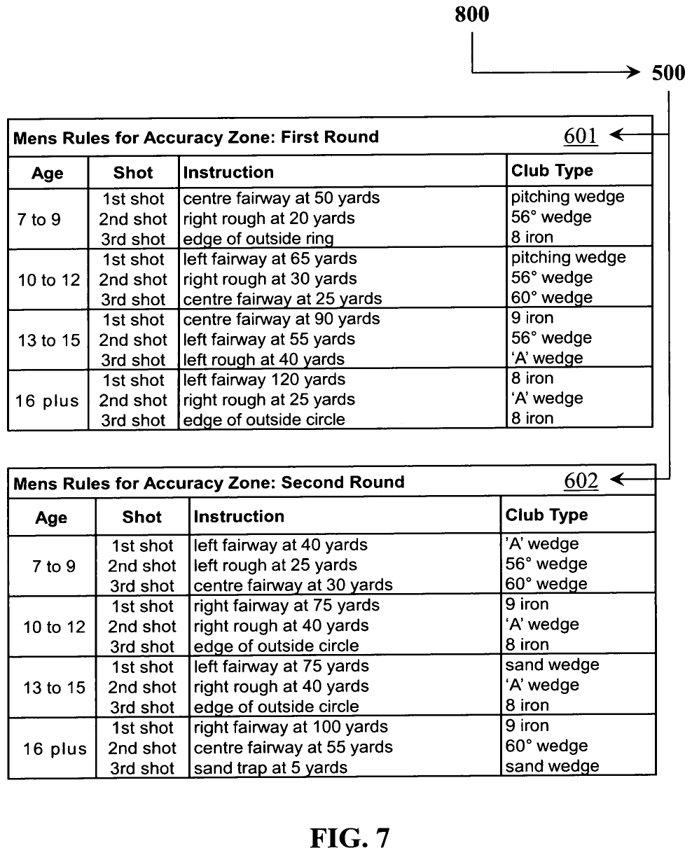

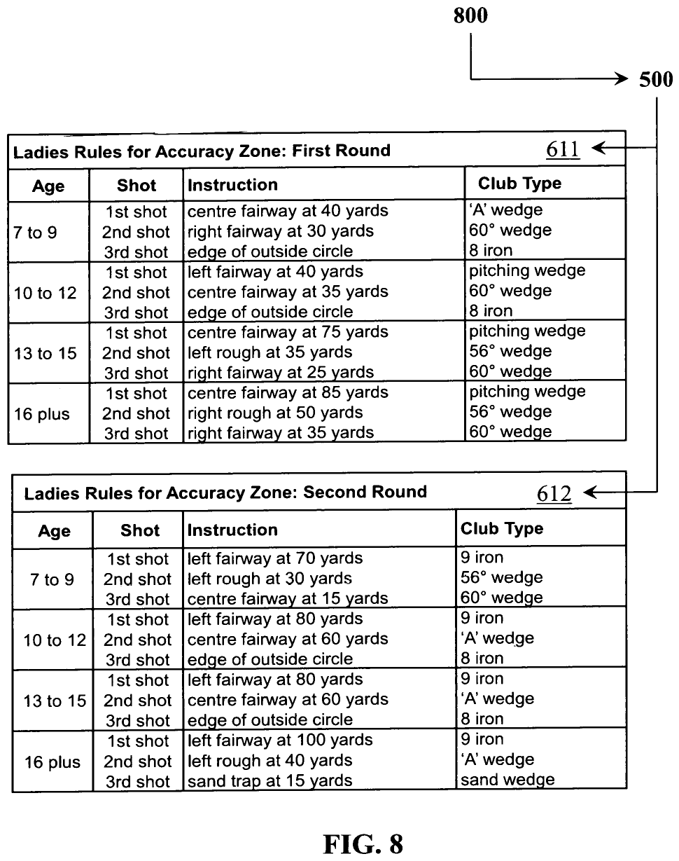

Referring to the embodiments (implementations) as depicted in FIG. 12 and FIG. 13, a second set of spaced-apart yardage markers may extend along another side (as indicated on the right side) of the accuracy zone 300 (as depicted in FIG. 13). The second set of spaced-apart yardage markers may extend, for instance, from the 120 yard marker to the zero marker, then further toward the rear 20 yard marker. The second set of spaced-apart yardage markers may be utilized for indicating yardage for the case where the accuracy zone 300 (as depicted in FIG. 13) is utilized with the predetermined set of rules 500 (as depicted in FIG. 7 and/or FIG. 8).

Referring to the embodiment (implementation) as depicted in FIG. 13, the accuracy zone 300 includes an accuracy-zone tee 122. The accuracy-zone tee 122 is configured to be used by the golf player. The golf player may strike the golf ball from the accuracy-zone tee 122 for the case where the golf player is using the second set of spaced-apart yardage markers (for when the golf player is using the predetermined set of rules 500, as depicted in FIG. 7 and/or FIG. 8).

FIG. 14 depicts a top view of a fifth embodiment (implementation) of a golf course 100, which is a synergistic combination of (a) the embodiment (implementation) of the golf course 100 of FIG. 1 and FIG. 2, (b) the embodiment (implementation) of the golf course 100 of FIG. 5 and FIG. 6, and (c) the embodiment (implementation) of the golf course 100 of FIG. 9.

Referring to the embodiment (implementation) as depicted in FIG. 14, the golf course 100 may include any combination and/or permutation of the power zone 200 (as depicted in FIG. 1 and FIG. 2), an accuracy zone 300 (as depicted in FIG. 5 and FIG. 6), and the reward zone 400 (as depicted in FIG. 9) in any desired quantity and/or shape thereof, etc. The golf course 100 may, for instance, include power zones (200A, 200B, 200C, 200D), accuracy zones (300A, 300B, 300C, 300D) and reward zones (400A, 400B, 400C, 400D), positioned in a predetermined sequence (ordering). For a first round, a golf player may play the golf game by travelling along the following direction: (a) the power zone 200A, the accuracy zone 300A and the reward zone 400A, (b) the power zone 200B, the accuracy zone 300B and the reward zone 400B, (c) the power zone 200C, the accuracy zone 300C and the reward zone 400C, and (d) the power zone 200D, the accuracy zone 300D and the reward zone 400D. For a second round, the golf player(s) may recirculate along the same path as taken for along the first round. The golf course 100 may, for instance, have dimensions of about 500 yards by about 330 yards (as depicted in FIG. 14). The golf course 100 has dimensions that permit, advantageously, a lower requirement for land size compared to known golf courses (thereby keeping land costs lower, etc.).

FIG. 3 depicts a front view schematic of a predetermined set of golf rules applicable to men that use the embodiment (implementation) of the golf course 100 of FIG. 1 and FIG. 2.

FIG. 4 depicts a front view schematic of a predetermined set of golf rules applicable to women that use the embodiment (implementation) of the golf course 100 of FIG. 1 and FIG. 2.

Referring to the embodiments (implementations) as depicted in FIG. 3 and FIG. 4, there is depicted a method 800 of playing a golf game that may be used by golf players on (a working surface 101 of) the golf course 100 in accordance with a predetermined set of rules 500 (also called golf rules, play rules, etc.).

Referring to the embodiments (implementations) as depicted in FIG. 3 and FIG. 4, the method 800 of playing the golf game (in accordance with a predetermined set of rules) may be utilized (by the golf players) for the purpose of reducing, at least in part, at least one technical problem (or, preferably, more than one technical problem) associated with: (a) the first technical problem pertaining to the golf clubs; and/or (b) the second technical problem pertaining to the golf balls; and/or (c) the third technical problem pertaining to the golf glove; and/or (d) the fourth technical problem pertaining to the golf shoes; and/or (e) the fifth technical problem pertaining to the usage of golf clubs.

Referring to the embodiments (implementations) as depicted in FIG. 3 and FIG. 4, the method 800 may further permit any one of: (a) encouragement for new golf players interested in playing golf; and (b) attracting a younger potential golf player; and (c) a reduced land size to be converted into the golf course 100; and (d) golf players to test and/or improve their skills; and (e) golf players to play a progressive, distilled golf game, etc.

Referring to the embodiments (implementations) as depicted in FIG. 3 and FIG. 4, the method 800 may be played, preferably, by four golf players (a foursome), in which the golf player(s) take(s) at least one shot or a predetermined number of club strokes. The club stroke is counted for a swing of the golf club. The method 800 may include having the golf player(s) playing at least one round (in which a predetermined number of club strokes is taken by each golf player on at least one zone of the golf course 100). The round (such as a first round) may include, for instance, nine club strokes including (a) three club strokes to be taken on the power zone 200, (b) three club strokes to be taken on the accuracy zone 300, and (c) three club strokes to be taken on the reward zone 400, etc. The method 800 includes, more preferably, having the golf player(s) play a predetermined total number of club strokes (such as 18 club strokes), such as (A) a first round (having a predetermined number of club strokes, such as nine strokes or three club strokes per zone of the golf course 100 for the case where three zones are utilized), and (B) a second round (having a predetermined number of club strokes, such as nine strokes or three club strokes per zone of the golf course 100 for the case where three zones (types of zones) are utilized). The method 800 may be played on the power zone 200, the accuracy zone 300 and the reward zone 400.

Referring to the embodiments (implementations) as depicted in FIG. 3 and FIG. 4, at each of the power zone 200, the accuracy zone 300, and the reward zone 400, a shot board may be installed. The shot board may be configured to display: (a) the club strokes to be played for a given zone; and (b) the golf club selection to be utilized for the given zone; and (c) the position of the zone on the golf course 100. The golf players may alternate their club strokes between themselves. It will be appreciated that the number of club strokes to be played for a given round may be different from the number of club strokes to be played for another round.

Referring to the embodiments (implementations) as depicted in FIG. 3 and FIG. 4, the method 800 of playing a golf game may be performed in accordance with a predetermined set of rules 500 on the power zone 200 (as depicted in FIG. 1 and FIG. 2) of the golf course 100.

Referring to the embodiment (implementation) as depicted in FIG. 3, the predetermined set of rules 500 includes, preferably, a predetermined set of first-round rules 501 (for males) and a predetermined set of second-round rules 502 (for males), preferably for a total of six club strokes, to be played (used) on the power zone 200 of the golf course 100 (as depicted in FIG. 1 and FIG. 2). The predetermined set of rules 500 may be categorized by the age of the golf player and/or the skill level of the golf player and/or the handicap of a golf player, etc. The predetermined set of first-round rules 501 is used by the male players (men) on the power zone 200 (as depicted in FIG. 1 and FIG. 2) for a first round having three club strokes per golf player. The predetermined set of second-round rules 502 is used by the male players (men) on the power zone 200 (as depicted in FIG. 1 and FIG. 2) for a second round having three club strokes per golf player. To improve the explanation of the predetermined set of rules 500, a total of two golf players are used. It will be appreciated that one golf player, three golf players (a threesome) or four golf players (a foursome) may use the predetermined set of rules 500. The first golf player takes (hits) a first club stroke (using a first golf club) from the first power tee 104 (performed on their designated golf ball). The second golf player takes a first club stroke (using a first golf club) from the first power tee 104 (performed on their designated golf ball). After the golf players have respectively completed their first club stroke, the golf players take their respective second club stroke from the first power tee 104. The first golf player takes (hits) a second club stroke (using a second golf club) from the first power tee 104 (performed on their designated golf ball). The second golf player takes a second club stroke (using a second golf club) from the first power tee 104 (performed on their designated golf ball). After the golf players have respectively completed their second club stroke, the golf players take their respective third club stroke from the first power tee 104. The first golf player takes (hits) a third club stroke (using a third golf club) from the first power tee 104 (performed on their designated golf ball). The second golf player takes a third club stroke (using a third golf club) from the first power tee 104 (performed on their designated golf ball).

Referring to the embodiment (implementation) as depicted in FIG. 3, the predetermined set of second-round rules 502 are used by the male players (men) on the power zone 200 (as depicted in FIG. 1 and FIG. 2) for a second round having three club strokes per golf player. For easing the explanation of the predetermined set of rules 500, a total of two golf players are used. The first golf player takes (hits) a fourth club stroke (using a fourth golf club) from the first power tee 104 (performed on their designated golf ball). The second golf player takes a fourth club stroke (using a fourth golf club) from the first power tee 104 (performed on their designated golf ball). After the golf players have respectively completed their fourth club stroke, the golf players take their respective fifth club stroke from the first power tee 104. The first golf player takes (hits) a fifth club stroke (using a fifth golf club) from the first power tee 104 (performed on their designated golf ball). The second golf player takes a fifth club stroke (using a fifth golf club) from the first power tee 104 (performed on their designated golf ball). After the golf players have respectively completed their fifth club stroke, the golf players take their respective sixth club stroke from the first power tee 104. The first golf player takes (hits) a sixth club stroke (using a sixth golf club) from the first power tee 104 (performed on their designated golf ball). The second golf player takes a sixth club stroke (using a sixth golf club) from the first power tee 104 (performed on their designated golf ball). Additional rules for the power zone 200 may include the following: (a) all shots must stop inside the designated boundaries; and (b) any golf ball stopping on a marker line may be scored in the higher bracket, etc. After the predetermined set of first-round rules 501 and the predetermined set of second-round rules 502 have been executed (completed), the golf players may record the distances travelled by their golf balls, and the golf players may move on to the accuracy zone 300 (as depicted in FIG. 5 and FIG. 6).

Referring to the embodiment (implementation) as depicted in FIG. 3, the predetermined set of first-round rules 501 (for males) and the predetermined set of second-round rules 502 (for males) may contain similarly-formatted rules. The predetermined set of rules 500 (or the predetermined set of first-round rules 501) may include a predetermined number of shots (shot numbers or club-strokes) to be taken for a golf player (each golf player). The predetermined number of shots are to be taken on (executed from) the working surface 101 of the power zone 200 of the golf course 100. For instance, the predetermined number of shots may include three (3) predetermined shots to be taken (executed) by the golf player (for each golf player). For instance, the predetermined number of shots (to be taken by the golf player) may include a first predetermined shot (predetermined shot number 1), a second predetermined shot (predetermined shot number 2) and a third predetermined shot (predetermined shot number 3), etc. The predetermined set of rules 500 (or the predetermined set of first-round rules 501) may also include a predetermined shot instruction (club-stroke instruction) for each predetermined number of shots (predetermined shot or shot number) to be taken by the golf player. A predetermined shot instruction is configured to instruct a golf player to stand at a predetermined location (on the working surface 101) from where the golf player may take their shot (club stroke) of the golf ball toward (along with) a predetermined shot target (predetermined target objective) for each predetermined shot to be taken by the golf player. For instance, the predetermined shot instruction may instruct the golf player to stand at the tee, and from the tee the golf player is to take a shot (execute the club stoke) in such a way that the golf ball travels from the tee as far as possible toward the opposite end of the working surface 101 (the objective is to practice a power-type shot for the power zone 200). For instance, the predetermined shot instruction may instruct the golf player to stand at the tee, and from the tee the golf player is to take a shot in such a way that the golf ball travels as close as possible to the 80 yard distance marker (a predetermined distance from the tee) at which place the golf ball may come to rest at a position located inside the 20 yard boundary straddling a centreline extending between the opposite ends of the working surface 101 (for this case, the objective is to practice an accurate power shot in the power zone 200). The predetermined set of rules 500 (or the predetermined set of first-round rules 501) may include a predetermined club-type identification for a given predetermined shot instruction; that is, a predetermined type of club is identified for a predetermined shot instruction (for each shot instruction or shot number) to be followed (taken, executed) by the golf player (for the golf players). For instance, (a) the first predetermined shot requires the golf player (each golf player) to use a driver club with the first predetermined shot instruction, (b) the second predetermined shot requires the golf player (each golf player) to use a 6-iron club with the second predetermined shot instruction, and (c) the third predetermined shot requires the golf player (each golf player) to use a 9-iron club with the third shot instruction, etc. After all the predetermined shots are taken (by the golf player or by each golf player) points may be tabulated and awarded accordingly. For instance, points may be awarded in accordance with a priority given to the golf player who best meets the predetermined shot target (objective) for a given predetermined shot (for each shot number). For instance, for the first predetermined shot, one point is awarded to the golf player that comes in first place for placing the golf ball closest to the first predetermined shot target, two points awarded for the golf player that comes in second place for playing the golf ball that is positioned second closest to the first predetermined shot target, etc.

Referring to the embodiment (implementation) as depicted in FIG. 3, the predetermined set of rules 500 (or the predetermined set of first-round rules 501) may include (predetermined) age categories. For instance, the age categories may include a first predetermined age category (for ages 7 to 9 years of age), a second predetermined age category (for ages 10 to 12 years of age), a third predetermined age category (for ages 13 to 15 years of age), and a fourth predetermined age category (for ages 16 years of age and higher). The predetermined set of rules 500 (or the predetermined set of first-round rules 501) may include a predetermined number of shots (shot numbers or club-stroke numbers) for each predetermined age category. For instance, shot number 1, shot number 2 and shot number 3 may be assigned for each predetermined age category. The predetermined set of rules 500 (or the predetermined set of first-round rules 501) may include a predetermined shot instruction for each shot number for each age category. The predetermined set of rules 500 (or the predetermined set of first-round rules 501) may include a predetermined club-type identification for each shot instruction for each age category.

Referring to the embodiment (implementation) as depicted in FIG. 4, the predetermined set of rules 500 includes, preferably, a predetermined set of first-round rules 511 (for females) and a predetermined set of second-round rules 512 (for females), preferably for a total of six club strokes, to be played (used) on the power zone 200 of the golf course 100. The predetermined set of first-round rules 511 is used by the female players (ladies) on the power zone 200 (as depicted in FIG. 1 and FIG. 2) for a first round having three club strokes per golf player. The predetermined set of second-round rules 512 is used by the female players (ladies) on the power zone 200 (as depicted in FIG. 1 and FIG. 2) for a second round having three club strokes per golf player. For providing an explanation for using the predetermined set of rules 500, a total of two golf players are used. It will be appreciated that a single golf player, three golf players (a threesome) or four golf players (a foursome) may play the predetermined set of rules 560. For instance, the ladies may take their club strokes from either (a) the first power tee 104 or (b) the second power tee 106. The predetermined set of first-round rules 511 associated with the female players is similar to the predetermined set of first-round rules 501 (as depicted in FIG. 3) associated with the male players. The predetermined set of first-round rules 511 (associated with the female players) may require different golf clubs called out for each club stroke in comparison to the predetermined set of first-round rules 501 associated with the male players. The predetermined set of second-round rules 512 (associated with the female players) may be (preferably) similar to the predetermined set of second-round rules 502 (as depicted in FIG. 3) associated with the male players. The predetermined set of second-round rules 512 (associated with the female players) may require different golf clubs called out for each club stroke in comparison to the predetermined set of second-round rules 502 (associated with the male players). After the predetermined set of first-round rules 511 and the predetermined set of second-round rules 512 have been executed (completed), the golf players may record the distances travelled by their golf balls, and the golf players may move on to the reward zone 400 (as depicted in FIG. 9).

FIG. 7 depicts a front view schematic of a predetermined set of golf rules applicable to men that use the embodiment (implementation) of the golf course 100 of FIG. 5 and FIG. 6.

FIG. 8 depicts a front view schematic of a predetermined set of golf rules applicable to women that use the embodiment (implementation) of the golf course 100 of FIG. 5 and FIG. 6.

Referring to the embodiments (implementations) as depicted in FIG. 7 and FIG. 8, the method 800 of playing a golf game may be performed in accordance with a predetermined set of rules 500 (also called golf rules, play rules, etc.) on the accuracy zone 300 (as depicted in FIG. 5 and FIG. 6) of the golf course 100.

Referring to the embodiment (implementation) as depicted in HU. 7, the predetermined set of rules 500 includes, preferably, a predetermined set of first-round rules 601 (for males) and a predetermined set of second-round rules 602 (for males), preferably, for a total of six club strokes, to be played (used) on the accuracy zone 300 of the golf course 100. The predetermined set of first-round rules 601 are used by the male players (men) on the accuracy zone 300 (as depicted in FIG. 5 and FIG. 6) for a first round having three club strokes per golf player. The predetermined set of second-round rules 602 are used by the male players (men) on the accuracy zone 300 (as depicted in FIG. 5 and FIG. 6) for a second round having three club strokes per golf player. For providing an explanation of the predetermined set of rules 500, a total of two golf players are used. It will be appreciated that one golf player, three golf players (a threesome) or four golf players (a foursome) may use the predetermined set of rules 500. The first golf player takes (hits) a first club stroke (using a first golf club) from a designated area (such as the 120 yard marker line) to be performed on their designated golf ball. The second golf player takes a first club stroke (using a first golf club) from the designated area (such as the 120 yard marker line) to be performed on their designated golf ball. After the golf players have respectively completed their first club strokes, the golf players take their respective second club strokes from the designated area (such as the 120 yard marker line). The first golf player takes (hits) a second club stroke (using a second golf club) from the designated area (such as the 120 yard marker line) to be performed on their designated golf ball. The second golf player takes a second club stroke (using a second golf club) from the designated area (such as the 120 yard marker line) to be performed on their designated golf ball. After the golf players have respectively completed their second club strokes, the golf players take their respective third club strokes from the designated area (such as the 120 yard marker line). The first golf player takes (hits) a third club stroke (using a third golf club) from the designated area (such as the 120 yard marker line) to be performed on their designated golf ball. The second golf player takes a third club stroke (using a third golf club) from the designated area (such as the 120 yard marker line) to be performed on their designated golf ball.

Referring to the embodiment (implementation) as depicted in FIG. 7, the predetermined set of second-round rules 602 are to be used by the male players (men) on the accuracy zone 300 (as depicted in FIG. 5 and FIG. 6) for a second round having a predetermined number of club strokes (such as three club strokes) per golf player. For providing an explanation of the predetermined set of rules 500, a total of two golf players are used. It is preferred that the limit of golf players is four players for forming a group that plays together. The first golf player takes (hits) a fourth club stroke (using a fourth golf club) from the designated area (such as the 120 yard marker line) to be performed on their designated golf ball. The second golf player takes a fourth club stroke (using a fourth golf club) from the designated area (such as the 120 yard marker line) to be performed on their designated golf ball. After the golf players have respectively completed their fourth club strokes, the golf players take their respective fifth club strokes from the designated area (such as the 120 yard marker line) to be performed on their designated golf ball. The first golf player takes (hits) a fifth club stroke (using a fifth golf club) from the designated area (such as the 120 yard marker line) to be performed on their designated golf ball. The second golf player takes a fifth club stroke (using a fifth golf club) from the designated area (such as the 120 yard marker line) to be performed on their designated golf ball. After the golf players have respectively completed their fifth club strokes, the golf players take their respective sixth club strokes from the designated area (such as the 120 yard marker line) to be performed on their designated golf ball. The first golf player takes (hits) a sixth club stroke (using a sixth golf club) from the designated area (such as the 120 yard marker line) to be performed on their designated golf ball. The second golf player takes a sixth club stroke (using a sixth golf club) from the designated area (such as the 120 yard marker line) to be performed on their designated golf ball. After the predetermined set of first-round rules 601 and the predetermined set of second-round rules 602 have been executed (completed), the golf players may record the distances travelled by their golf balls, and the golf players may move on to the reward zone 400 (as depicted in FIG. 9).

Referring to the embodiment (implementation) as depicted in FIG. 7, additional rules for the accuracy zone 300 may include the following: (a) all club strokes must stop inside the designated boundaries; and (b) scoring of points (awarded points) depends on the distance (yardage) that the golf ball travelled for a given club stroke; and (c) the positions of assigned club strokes may be shown on a scorecard (known and not depicted), a club-stroke board, etc.

Referring to the embodiment (implementation) as depicted in FIG. 8, the predetermined set of rules 500 includes, preferably, a predetermined set of first-round rules 611 (for females) and a predetermined set of second-round rules 612 (for females), preferably, for a total of six club strokes, to be played (used) on the accuracy zone 300 of the golf course 100. The predetermined set of first-round rules 611 are used by the female players (ladies) on the accuracy zone 300 (as depicted in FIG. 5 and FIG. 6) for a first round having three club strokes per golf player. The predetermined set of second-round rules 612 are used by the female players (ladies) on the accuracy zone 300 (as depicted in FIG. 5 and FIG. 6) for a second round having three club strokes per golf player. The ladies may take their club strokes from the designated area (such as the 120 yard marker line) to be performed on their designated golf balls. The predetermined set of first-round rules 611 associated with the female players is similar to the predetermined set of first-round rules 601 (as depicted in FIG. 7) associated with the male players. The predetermined set of first-round rules 611 associated with the female players may require different golf clubs called out for each club stroke in comparison to the predetermined set of first-round rules 601 associated with the male players. The predetermined set of second-round rules 612 associated with the female players is similar to the predetermined set of second-round rules 602 (as depicted in FIG. 7) associated with the male players. The predetermined set of second-round rules 612 associated with the female players may require different golf clubs called out for each club stroke in comparison to the predetermined set of second-round rules 602 associated with the male players. After the predetermined set of first-round rules 611 and the predetermined set of second-round rules 612 have been executed (completed), the golf players may record the distances travelled by their golf balls, and the golf players may move on to the reward zone 400 (as depicted in FIG. 9).

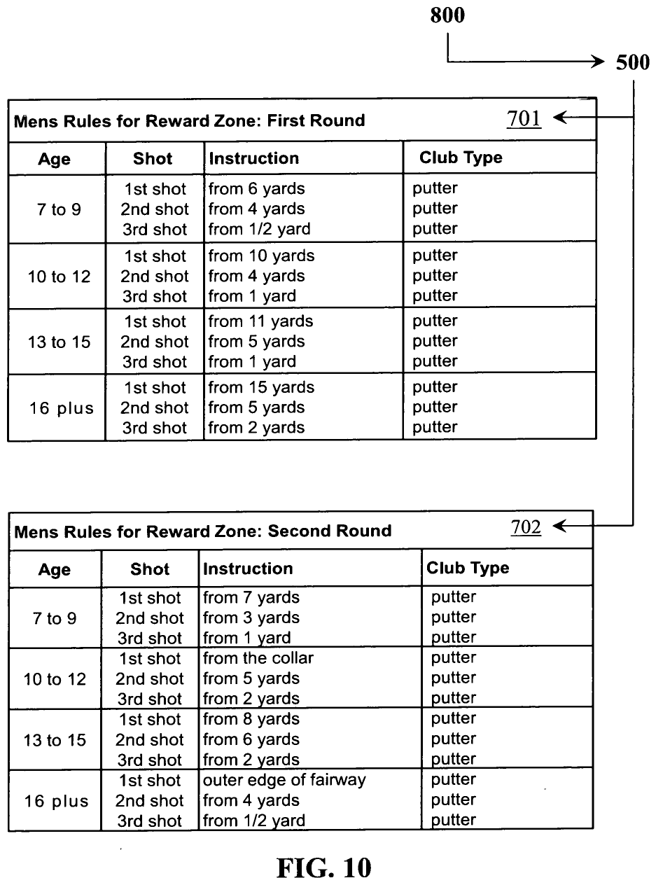

FIG. 10 depicts a front view schematic of a predetermined set of golf rules (applicable to men or males) that uses the embodiment (implementation) of the golf course 100 of FIG. 9.

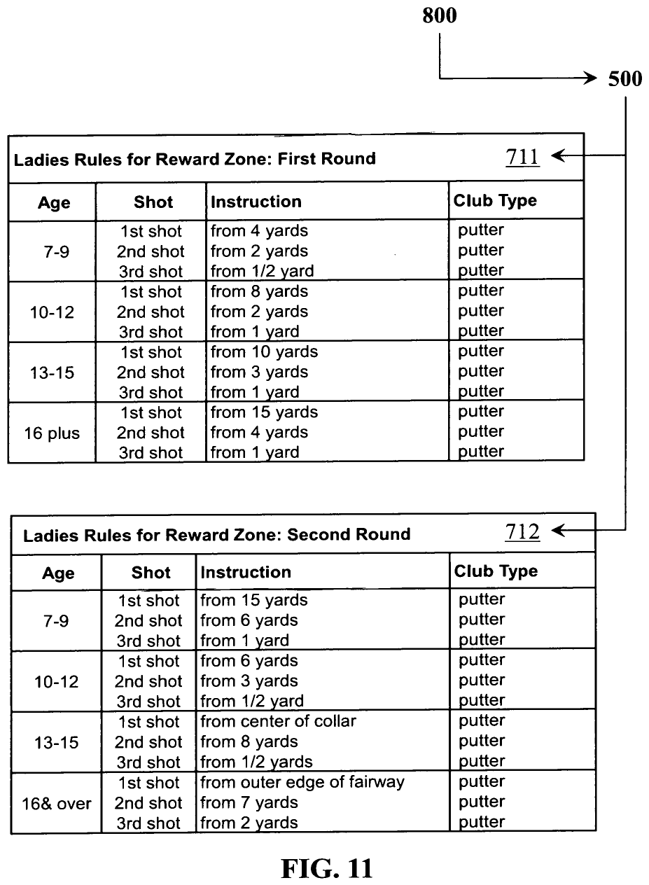

FIG. 11 depicts a front view schematic of a predetermined set of golf rules (applicable to women or females) that uses the embodiment (implementation) of the golf course 100 of FIG. 9.

Referring to the embodiments (implementations) as depicted in FIG. 10 and FIG. 11, the method 800 of playing a golf game may be performed in accordance with a predetermined set of rules 500 (also called golf rules, play rules, etc.) on the reward zone 400 (as depicted in FIG. 9) of the golf course 100.

Referring to the embodiment (implementation) as depicted in FIG. 10, the predetermined set of rules 500 includes, preferably, a predetermined set of first-round rules 701 (for males) and a predetermined set of second-round rules 702 (for males), preferably for a total of six club strokes, to be played (used) on the reward zone 400 of the golf course 100. The predetermined set of first-round rules 701 is used by the male players (men) on the reward zone 400 (as depicted in FIG. 9) for a first round having three club strokes per golf player. The predetermined set of second-round rules 702 is used by the male players (men) on the reward zone 400 (as depicted in FIG. 9) for a second round having three club strokes per golf player. For providing an explanation of the predetermined set of rules 500, a total of two golf players are used. It will be appreciated that a single golf player, three golf players (a threesome) or four golf players (a foursome) may play together, etc. The first golf player takes (hits) a first club stroke (using, preferably, the putter or putter club) from the designated area (performed on their designated golf ball). The second golf player takes a first club stroke (using, preferably, the putter) from the designated area (performed on their designated golf ball). After the golf players have respectively completed their first club strokes, the golf players take their respective second club strokes from the same or other designated area (performed on their designated golf ball). The first golf player takes (hits) a second club stroke (using, preferably, the putter) from the designated area (performed on their designated golf ball). The second golf player takes a second club stroke (using, preferably, the putter) from the designated area (performed on their designated golf ball). After the golf players have respectively completed their second club strokes, the golf players take their respective third clubs stroke from the same or other designated area. The first golf player takes (hits) a third club stroke (using, preferably, the putter) from the designated area (performed on their designated golf ball). The second golf player takes a third club stroke (using, preferably, the putter) from the designated area (performed on their designated golf ball).

Referring to the embodiment (implementation) as depicted in FIG. 10, additional rules for the accuracy zone 300 may include the following: (a) any golf ball stopping on a distance marker line may be scored in a higher bracket; and (b) scoring (awarded points) may depend on the distance travelled for a given shot, etc.

Referring to the embodiment (implementation) as depicted in FIG. 10, the predetermined set of second-round rules 702 is used by the male players (men) on the reward zone 400 (as depicted in FIG. 9) for a second round having three club strokes per golf player. To provide an explanation of the predetermined set of rules 500, a total of two golf players are used. The first golf player takes (hits) a fourth club stroke (using, preferably, the putter) from the designated area (performed on their designated golf ball). The second golf player takes a fourth club stroke (using, preferably, the putter) from the designated area (performed on their designated golf ball). After the golf players have respectively completed their fourth club strokes, the golf players take their respective fifth club strokes from the same or other designated area. The first golf player takes (hits) a fifth club stroke (using, preferably, the putter) from the designated area (performed on their designated golf ball). The second golf player takes a fifth club stroke (using, preferably, the putter) from the designated area (performed on their designated golf ball). After the golf players have respectively completed their fifth club strokes, the golf players take their respective sixth club strokes from the same or other designated area. The first golf player takes (hits) a sixth club stroke (using, preferably, the putter) from the designated area (performed on their designated golf ball). The second golf player takes a sixth club stroke (using, preferably, the putter) from the designated area (performed on their designated golf ball). After the predetermined set of first-round rules 701 and the predetermined set of second-round rules 702 have been executed (completed), the golf players may record the distances travelled by their golf balls, and the golf game may end (stop).

Referring to the embodiment (implementation) as depicted in FIG. 11, the predetermined set of rules 500 includes, preferably, a predetermined set of first-round rules 711 (for females) and a predetermined set of second-round rules 712 (for females), preferably, for a total of six club strokes, to be played (used) on the reward zone 400 (as depicted in FIG. 9) of the golf course 100. The predetermined set of first-round rules 711 are used by the female players (ladies) on the reward zone 400 (as depicted in FIG. 9) for a first round having three club strokes per golf player. The predetermined set of second-round rules 712 are used by the female players (ladies) on the reward zone 400 (as depicted in FIG. 9) for a second round having three club strokes per golf player. To provide an explanation of the predetermined set of rules 500, a total of two golf players are used. It will be appreciated that a single golf player, three golf players (a threesome) or four golf players (a foursome) may play together, etc. The predetermined set of first-round rules 711 associated with the female players may be similar to the predetermined set of first-round rules 701 (as depicted in FIG. 10) associated with the male players. The predetermined set of second-round rules 712 associated with the female players may be similar to the predetermined set of second-round rules 702 (as depicted in FIG. 10) associated with the male players. After the predetermined set of first-round rules 711 and the predetermined set of second-round rules 712 have been executed (completed), the golf players may record the distances travelled by their golf balls, and the golf game may end (stop).

Referring to the embodiment (implementation) as depicted in FIG. 4, FIG. 7 and FIG. 10, a sequence (a sequence of play), such as for males (men), may be used for playing the power zone 200, the accuracy zone 300, and the reward zone 400, for a total of 18 club strokes. The sequence may be played in accordance with the predetermined set of rules 500 (for males), in accordance with any one of (or all of): (a) playing the first round, in accordance with the predetermined set of first-round rules 501 (as depicted in FIG. 3), for the power zone 200 (as depicted in FIG. 1 and FIG. 2); and (b) followed by playing the first round, in accordance with the predetermined set of first-round rules 601 (as depicted in FIG. 7), for the accuracy zone 300 (as depicted in FIG. 5 and FIG. 6); and (c) followed by playing the first round, in accordance with the predetermined set of first-round rules 701 (as depicted in FIG. 10), for the reward zone 400 (as depicted in FIG. 9); and (d) followed by playing the second round, in accordance with the predetermined set of second-round rules 502 (as depicted in FIG. 3), for the power zone 200; and (e) followed by playing the second round, in accordance with the predetermined set of second-round rules 602 (as depicted in FIG. 7), for the accuracy zone 300; and (f) followed by playing the second round, in accordance with the predetermined set of second-round rules 702 (as depicted in FIG. 10), for the reward zone 400.

Referring to the embodiment (implementation) as depicted in FIG. 6, FIG. 8 and FIG. 11, a sequence (play sequence) may be played, such as for females (ladies), for playing the power zone 200, the accuracy zone 300, and the reward zone 400, for a total of 18 club strokes. The sequence may be played in accordance with the predetermined set of rules 500 for females, such as in accordance with any one of (or all of): (a) the predetermined set of first-round rules 511 (as depicted in FIG. 4) for the power zone 200; and (b) the predetermined set of first-round rules 611 (as depicted in FIG. 8) for the accuracy zone 300; and (c) the predetermined set of first-round rules 711 (as depicted in FIG. 11) for the reward zone 400; and (d) the predetermined set of second-round rules 512 (as depicted in FIG. 4) for the power zone 200; and (e) the predetermined set of second-round rules 612 (as depicted in FIG. 8) for the accuracy zone 300; and (f) the predetermined set of second-round rules 712 (as depicted in FIG. 11) for the reward zone 400.

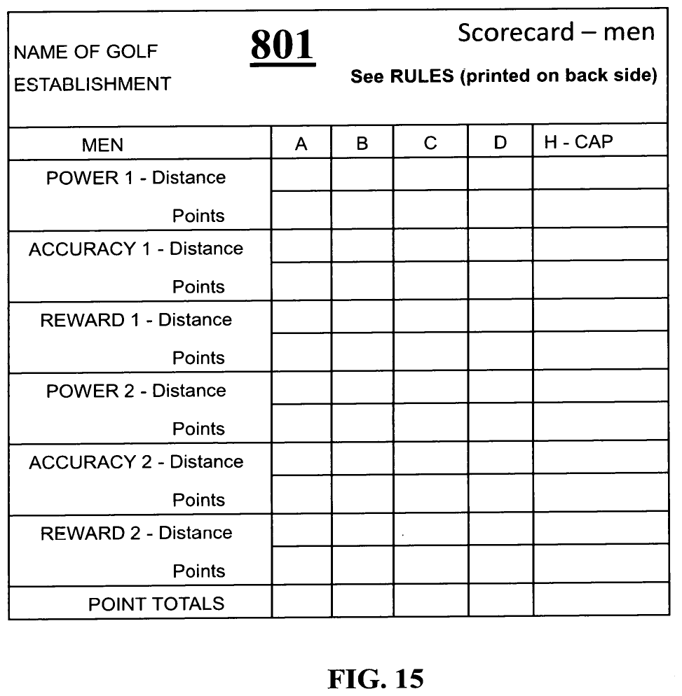

FIG. 15 depicts a front view of a golf scorecard 801 applicable to men that use (a) the embodiment (implementation) of the golf course 100 of FIG. 1 and FIG. 2, (b) the embodiment (implementation) of the golf course 100 of FIG. 5 and FIG. 6, and (c) the embodiment (implementation) of the golf course 100 of FIG. 9.

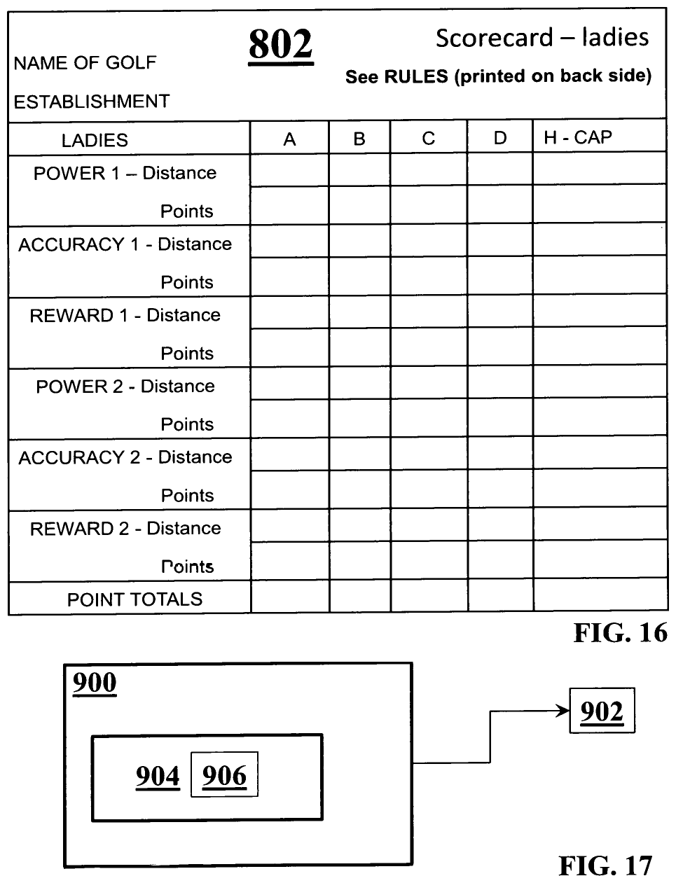

FIG. 16 depicts a front view of a golf scorecard 802 applicable to men that use (a) the embodiment (implementation) of the golf course 100 of FIG. 1 and FIG. 2, (b) the embodiment (implementation) of the golf course 100 of FIG. 5 and FIG. 6, and (c) the embodiment (implementation) of the golf course 100 of FIG. 9.

Referring to the embodiments (implementations) as depicted in FIG. 15 and FIG. 16, each golf player may score points, as allocated, on each discipline. The golf player who is closest to the appointed target or distance without going past is awarded one point. Points may be accumulated closest to a predetermined number (such as 18 shots or club strokes) is declared the overall winner of the golf game. In the event of a tie for any given club stroke, each golf player is awarded the same corresponding score, such as: (a) one point for golf players tied for first position; and (b) two points for golf players tied for second position; and (c) three points for golf players tied for third position, etc.

In a team match, the total points (for the team members) are added, and the total team points closest to zero is declared the winner. An international electronic scoring system could be employed that could eliminate any discrepancies and lend itself to competitive play, between home leagues and international leagues. The scorecards have a box for entering the distance of particular shots so that a player can keep track of their shots (or yardage distances, etc.) each time they play the golf course 100. Utilizing a central scoring system may allow time flexibility when golf players from different countries or localities are competing against one another. Depending upon the countries, there may be a twelve hour time difference, but because the scores are recorded and the golf players may not have to play at the same time. A maximum time delay may be implemented so that competitors may have to submit a score within a certain number of hours.

Referring to the embodiments (implementations) as depicted in FIG. 15 and FIG. 16, points may be assigned (awarded) to a golf player in accordance with a point protocol. For instance, points may be assigned (awarded) to a golf player in accordance with a point protocol depending on the rank they achieve for their club stroke. For instance, the point protocol may include the following: (a) one point awarded for using a club stroke achieving the longest distance for their golf ball (or sinking their golf ball in the cup 120, as depicted in FIG. 9); and (b) two points awarded for using a club stroke achieving the second longest distance for their golf ball; and (c) three points awarded for using a club stroke achieving the third longest distance for their golf ball; and (d) four points awarded for using a club stroke achieving the fourth longest distance for their golf ball, etc. The golf player who has the least number of points is declared the winner (either at the end of the game or at the end of a round of play). In the event of a tie score, the tied golf players may be awarded the same points: (a) one point each when the golf players are tied for the longest distance for their golf ball (or sinking their golf ball in the cup 120, as depicted in FIG. 9); and (b) two points each when the golf players are tied for the second longest distance for their golf ball; and (c) three points each when the golf players are tied for the third longest distance for their golf ball.

League Play

Leagues may be formed for the golf course 100. A league may include golf players of different skill sets and/or ages: juniors (different age brackets) ladies, men, seniors and mixed. A league may be formed to embrace different skill levels, such as premier league, first division, second division, etc. Each league category may accommodate different skill levels based on a handicapping system. At the end of a season, the top three golf players may go up to the next higher division and the bottom three players may be relegated to the next lower division. At the end of each month, the top three players, plus ties, in each category, may compete for a monthly trophy. At the end of a season, the top three players, plus ties, may compete for a season trophy, preferably by category, such as age category.

Play Timing

A time limit may be applied for playing the predetermined set of rules 500, and may include the following time limits: (a) 20 minutes for a single golf player; and (b) 40 minutes for two golf players; and (c) 60 minutes for three golf players; and (d) 80 minutes for four golf players.

Additional Rules

Rules may be set for leagues, competitive games, etc., and may include (for instance) any one of: (a) no more than four golf players per group; and (b) all golf balls must stop inside the designated boundaries; and (c) any golf ball stopping on a distance marker line may be scored in a higher bracket; and (d) a golf ball stopping on a designated boundary line may be scored in an appropriate target area; and (e) a golf ball that strikes a security barrier (screen) may be scored from where the golf ball stops movement; and (f) for the accuracy zone 300 and/or the reward zone 400, scoring may be measured from the cup 120, etc.; and (g) after distance is recorded in the accuracy zone 300 and the reward zone 400, a golf player must pick up their golf ball before the next golf player may play; and (h) recreational golf players may play a predetermined play format or may make their own (reasonable) format.

Installation

The golf course 100 may be installed on a rooftop of a building, such as an office, a hotel, a condominium building, etc., thereby potentially providing a positive benefit for both golfers and non-golfers. The golf course 100 may have floodlights installed to allow night time playing. The golf course 100 may have a projector configured to project views to a screen, such as views of trees, rough, water and other scenes of nature, creating a traditional golf course ambiance. The golf course 100 may be installed on a cruise ship that may have sufficient space to install an aspect of the golf course 100.

Revenue

The owner of the golf course 100 may derive revenue from different sources. The owner of the golf course 100 may lease the golf course 100. The owner of the golf course 100 may negotiate to share in the revenue. There may be an initial fee to join a league, and thereafter, a fee may be applicable (per game, etc.). There may be a pay-as-you-play fee, which may be applied for non-members, etc. A fee may be charged on a time basis. When users desire to book a tee time, the users may specify how long they wish to play, such as any one of the following: (a) 20 minutes for a single golf player to complete 18 club strokes; and (b) 60 minutes for three golf players to complete 18 club strokes; and (c) 80 minutes for four players to complete 18 club strokes.

FIG. 17 depicts a schematic view of an electronic device 900 configured to display, on a display device 902, an image of a working surface 101 of a golf course 100, and the electronic device 900 is also configured to display and animate an electronically-simulated golf game in accordance with a method 800.

Referring to the embodiment (implementation) as depicted in FIG. 17, the method 800 of playing a golf game may be used by golf players on a display device 902 of an electronic device 900 that displays a working surface 101 of a golf course 100. The method 800 may be played in accordance with a predetermined set of rules 500. The method 800 may be utilized in an electronically-simulated golf game; in this manner, the golf players may practise the method 800 of a simulated golf game in anticipation of playing on the golf course 100. The method 800 may be implemented in an executable program 906 as a video game configured to simulate the golf game. The electronic device 900 is configured to display, on a display device 902, an image (to the user) of a working surface 101 of a golf course 100, and the electronic device 900 is also configured to display and animate an electronically-simulated golf game in accordance with a method 800. The electronic device 900 is configured to operatively connect with a display device 902. The electronic device 900 has a memory 904 configured to tangibly store an executable program 906. The executable program 906 includes coded instructions (programmed coded instructions) configured to be readable by, and executable by, the electronic device 900. The executable program 906 is configured to urge the electronic device 900 to perform predetermined operations (calculations, comparisons, etc.). Equivalents to the executable program 906 may include (and are not limited to): (a) machine-language code; and (b) assembly-language code; and (c) source code formed in a high-level computing language understood by humans (the high-level computing language may be compiled into either an executable machine code file or a non-executable machine-code object file); and (d) an application-specific integrated circuit; and (e) a field-programmable gate array (FPGA), and any equivalent(s) thereof. One of skill in the art will immediately appreciate that the embodiments may be practiced with set-top boxes, hand-held devices, multiprocessor systems, microprocessor-based system, programmable consumer electronics, network computers, minicomputers, mainframe computers, and the like. The electronic device 900 may include, for instance, a processing unit (a processor assembly), which may include, for instance, the INTEL (TRADEMARK) PENTIUM (TRADEMARK) microprocessor, the MOTOROLA (TRADEMARK) Power PC (TRADEMARK) microprocessor, etc., and any equivalent thereof. One of skill in the art will immediately recognize that the memory 904 (memory assembly, a computer-readable medium, a machine-readable medium, etc., and any equivalent thereof) may include any type of storage device configured to be accessible by a processor, etc. The memory 904 may be embodied on a magnetic hard disk or an optical disk having executable instructions to cause the processor to perform a computing method (operational steps or computing operations, etc.). Computer hardware (operating components and any equivalent thereof) suitable for performing the processes of the embodiments are not intended to limit the applicable environments.

### ADDITIONAL DESCRIPTION

The following clauses are offered as further description of embodiments of the method. Any one or more of the following clauses may be combinable with any other one or more of the following clauses and/or with any subsection or a portion or portions of any other clause and/or combination and permutation of clauses. Any one of the following clauses may stand on its own merit without having to be combined with any other clause or with any portion of any other clause, etc. Clause (1): a method 800 of playing a golf game, on a working surface 101 of a golf course 100, the method 800 comprising using a predetermined set of rules 500 being configured to identify, to a golf player, a range of golf clubs of a set of golf clubs to be utilized in such a way that the predetermined set of rules 500, in use, promotes, at least in part, a prolonged life span of at least one golf club of the set of golf clubs. Clause (2): the method 800 of clause (1), further comprising taking predetermined shot numbers indicating a number of club strokes to be taken by the golf player as set out in the predetermined set of rules 500. Clause (3): the method 800 of clause (2), further comprising executing a club stroke in accordance with a predetermined shot instruction being associated with each predetermined shot number as set out in the predetermined set of rules 500. Clause (4): the method 800 of clause (2), further comprising executing a club stroke in accordance with a predetermined shot instruction configured to instruct the golf player to stand at a predetermined location, on the working surface 101, from where the golf player is to take a shot toward a shot target for each predetermined shot number as set out in the predetermined set of rules 500. Clause (5): the method 800 of clause (2), further comprising executing a club stroke with a predetermined club-type identification being associated with a predetermined shot instruction, in which the predetermined club-type identification is configured to identify a predetermined golf club to be used by the golf player as set out in the predetermined set of rules 500. Clause (6): the method 800 of clause (2), wherein the predetermined set of rules 500 includes age categories. Clause (7): the method 800 of clause (6), wherein the predetermined set of rules 500 also includes, for each category of said age categories, said predetermined shot numbers configured to indicate a number of club strokes to be taken by the golf player. Clause (8): the method 800 of clause (7), wherein the predetermined set of rules 500 also includes, for each category of said age categories, a predetermined shot instruction being respectively associated with said predetermined shot numbers. Clause (8): the method 800 of clause (7), wherein the predetermined set of rules 500 also includes predetermined club-type identifications, in which a predetermined club-type identification identifies a unique golf club to be used by the golf player.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the disclosure which does not materially modify the disclosure. Similarly, unless specifically made clear from its context, numerical values should be construed to include certain tolerances that the person skilled in the art would recognize as having negligible importance as they do not materially change the operability of the disclosure. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options may be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method 800 steps. Comprising (comprised of) is an “open” phrase and allows coverage of technologies that employ additional, unrecited elements. When used in a claim, the word “comprising” is the transitory verb (transitional term) that separates the preamble of the claim from the technical features of the disclosure. The foregoing has outlined the non-limiting embodiments (examples). The description is made for particular non-limiting embodiments (examples). It is understood that the non-limiting embodiments are merely illustrative as examples.

What is claimed is:

1. A method of playing a golf game, on a working surface of a golf course, the method comprising:
providing a predetermined set of rules being configured to identify, to a golf player, a range of golf clubs of a set of golf clubs to be utilized in such a way that the predetermined set of rules, in use, promotes, at least in part, a prolonged life span of at least one golf club of the set of golf clubs.

2. The method of claim 1, wherein:
the predetermined set of rules includes predetermined shot numbers for indicating a number of club strokes to be taken by the golf player.

3. The method of claim 2, wherein:
the predetermined set of rules also includes a predetermined shot instruction being associated with each predetermined shot number.

4. The method of claim 2, wherein:
the predetermined set of rules also includes a predetermined shot instruction configured to instruct the golf player to stand at a predetermined location, on the working surface, from where the golf player is to take a shot toward a shot target for each predetermined shot number.

5. The method of claim 2, wherein:
the predetermined set of rules also includes a predetermined club-type identification being associated with a predetermined shot instruction, in which a the predetermined club-type identification is configured to identify a predetermined golf club to be used by the golf player.

6. The method of claim 2, wherein:
points are awarded after the number of club strokes are executed.

7. The method of claim 2, wherein:
the predetermined set of rules includes age categories.

8. The method of claim 7, wherein:
the predetermined set of rules also includes an indication of predetermined shot numbers for each category of said age categories.

9. The method of claim 8, wherein:
the predetermined set of rules also includes, for each category of said age categories, a predetermined shot instruction respectively associated with a predetermined shot number.

10. The method of claim 9, wherein:
the predetermined set of rules also includes predetermined club-type identifications configured to identify unique golf clubs to be used by the golf player.

11. The method of claim 1, wherein:
the predetermined set of rules includes:
a predetermined first set of rules for playing golf on a power zone of the golf course; and
a predetermined second set of rules for playing golf on an accuracy zone of the golf course; and
a predetermined third set of rules for playing golf on a reward zone of the golf course.

12. A method of playing a golf game, on a working surface of a golf course, the method comprising:
using a predetermined set of rules being configured to identify, to a golf player, a range of golf clubs of a set of golf clubs to be utilized; and
the predetermined set of rules includes predetermined shot numbers for indicating a number of club strokes to be taken by the golf player; and
the predetermined set of rules also includes a predetermined shot instruction:
being associated with a respective predetermined shot number; and
being configured to instruct the golf player to stand at a predetermined location, on the working surface, from where the golf player is to take a shot toward a shot target for each predetermined shot number; and
the predetermined set of rules also includes a predetermined club-type identification:
being associated with a unique predetermined shot instruction; and
being configured to identify a predetermined golf club to be used by the golf player.

13. The method of claim 12, wherein:
the predetermined set of rules also includes:
age categories; and
an indication of predetermined shot numbers for each category of said age categories; and
a unique predetermined shot instruction respectively associated with a unique predetermined shot number for each category of said age categories; and
a unique predetermined club-type identification associated with each unique predetermined shot number for each category of said age categories.

14. A method of playing a golf game, on a working surface of a golf course, the method comprising:
using a predetermined set of rules being configured to identify, to a golf player, a range of golf clubs of a set of golf clubs to be utilized in such a way that the predetermined set of rules, in use, promotes, at least in part, a prolonged life span of at least one golf club of the set of golf clubs; and
taking a set of predetermined shot numbers indicating a number of club strokes to be taken by the golf player as set out in the predetermined set of rules; and
executing at least one club stroke in accordance with a predetermined shot instruction:
being associated with each predetermined shot number as set out in the predetermined set of rules; and
being configured to instruct the golf player to stand at a predetermined location, on the working surface, from where the golf player is to take a shot toward a shot target for each predetermined shot number as set out in the predetermined set of rules; and
executing said at least one club stroke with a predetermined club-type identification:
being associated with a unique predetermined shot instruction; and
being configured to identify a predetermined golf club to be used by the golf player as set out in the predetermined set of rules.

15. The method of claim 14, wherein:
the predetermined set of rules includes age categories; and
the predetermined set of rules also includes, for each category of said age categories, predetermined shot instructions being respectively associated with predetermined shot numbers; and
the predetermined set of rules also includes, for each category of said age categories, a unique predetermined club-type identification:
being configured to identify a unique golf club to be used by the golf player, and
being respectively associated with a unique predetermined shot instruction.

16. A golf course having a working surface for use with a method of playing a golf game, and the method comprising using a predetermined set of rules is configured to identify a range of golf clubs of a set of golf clubs to be utilized in such a way that the predetermined set of rules promotes, at least in part, a prolonged life span of at least some golf clubs of the set of golf clubs.

17. A working surface of a golf course for use with a method of playing a golf game in accordance with a predetermined set of rules, and the method comprising: providing the predetermined set of rules is configured to identify a range of golf clubs of a set of golf clubs to be utilized in such a way that the predetermined set of rules promotes, at least in part, a prolonged life span of at least some golf clubs of the set of golf clubs.

18. An electronic device configured to display, on a display device, an image of a working surface of a golf course, the electronic device also configured to display and animate an electronically-simulated golf game in accordance with a method comprising: using a predetermined set of rules configured to identify a range of golf clubs of a set of golf clubs to be utilized in such a way that the predetermined set of rules promotes, at least in part, a prolonged life span of at least some golf clubs of the set of golf clubs.

19. An apparatus, comprising:
a golf course having a working surface.

20. The apparatus of claim 19, wherein:
the golf course further comprises a power zone, including:
spaced-apart elongated power-zone golf-ball deflector assemblies positioned on opposite lateral sides of the power zone, and the spaced-apart elongated power-zone golf-ball deflector assemblies being configured to deflect, in use, at least one golf ball back to the power zone; and
a first power end section positioned between the spaced-apart elongated power-zone golf-ball deflector assemblies; and
a second power end section positioned between the spaced-apart elongated power-zone golf-ball deflector assemblies, and the second power end section spaced apart from the first power end section; and
a power tee positioned at the first power end section, and the power tee configured to provide an area for a golf player to strike a golf ball from the first power end section toward the second power end section and between the spaced-apart elongated power-zone golf-ball deflector assemblies; and
spaced-apart distance markers configured to: extend between the spaced-apart elongated power-zone golf-ball deflector assemblies; and be position from the first power end section to the second power end section; and provide visual feedback as to a distance travelled by the golf ball along the power zone; and
a target zone configured to: be positioned between the spaced-apart elongated power-zone golf-ball deflector assemblies; and be positioned proximate to the second power end section; and provide visual target for hitting the golf ball from the first power end section.

21. The apparatus of claim 20, wherein:
the power zone also includes spaced-apart elongated lateral sides respectively extending along the spaced-apart elongated power-zone golf-ball deflector assemblies.

22. The apparatus of claim 20, wherein:
the golf course further comprises an accuracy zone including:
spaced-apart elongated golf-ball accuracy-zone deflector assemblies positioned on opposite lateral sides of the accuracy zone, and the spaced-apart elongated accuracy-zone golf-ball deflector assemblies being configured to deflect, in use, said at least one golf ball back to the accuracy zone; and
a first accuracy end section positioned between the spaced-apart elongated accuracy-zone golf-ball deflector assemblies; and
a second accuracy end section positioned between the spaced-apart elongated accuracy-zone golf-ball deflector assemblies, and the second accuracy end section spaced apart from the first accuracy end section; and
the first accuracy end section and the second accuracy end section spaced apart from each other; and
the first accuracy end section configured to provide an area for the golf player to strike the golf ball from the first accuracy end section toward the second accuracy end section and between the spaced-apart elongated accuracy-zone golf-ball deflector assemblies; and
a rough portion positioned between the spaced-apart elongated accuracy-zone golf-ball deflector assemblies, and the rough portion also positioned between the first accuracy end section and the second accuracy end section; and
a sand trap positioned between the spaced-apart elongated accuracy-zone golf-ball deflector assemblies, and the rough portion also positioned between the first accuracy end section and the second accuracy end section; and
a accuracy target area configured to: be positioned between the spaced-apart elongated accuracy-zone golf-ball deflector assemblies; and be positioned proximate to the second accuracy end section; and provide visual target for hitting the golf ball thereto from the first accuracy end section.

23. The apparatus of claim 22, wherein:
the accuracy zone also includes spaced-apart elongated lateral sides respectively extending along the spaced-apart elongated accuracy-zone golf-ball deflector assemblies.

24. The apparatus of claim 22, wherein:
the golf course further comprises a reward zone including:
a cup configured to receive a rolling golf ball; and
a set of spaced-apart concentric visual rings of different diameters concentrically surrounding the cup; and the set of spaced-apart concentric visual rings being configured to respectively measure a remaining distance to the cup.
